(19) United States
(12) Patent Application Publication
(10) Pub. No.: US 2024/0221580 A1
(43) Pub. Date: Jul. 4, 2024

(54) DISPLAY DEVICE AND DRIVING METHOD

(71) Applicant: LG Display Co., Ltd., Seoul (KR)

(72) Inventors: Dahye KWON, Seoul (KR); Sanggoo JEONG, Paju-si (KR); Min KIM, Seoul (KR)

(21) Appl. No.: 18/523,343

(22) Filed: Nov. 29, 2023

(30) Foreign Application Priority Data
Dec. 30, 2022 (KR) 10-2022-0190943

(51) Int. Cl. G09G 3/20; G09G 3/3233

(52) U.S. Cl. CPC G09G 3/2022; G09G 3/3233; G09G 2300/0819; G09G 2300/0842; G09G 2310/08; G09G 2320/0252

(57) ABSTRACT

According to embodiments of the present disclosure, there may be provided a display device and a driving method thereof. A first subpixel is electrically connected to a first data line and a first reference voltage line, a second subpixel is electrically connected to the first data line and a second reference voltage line different from the first reference voltage line, and magnitudes of a voltage supplied to the first reference voltage line and a voltage supplied to the second reference voltage line are different from each other. Thus, it is possible to efficiently improve a moving picture response time.

### CROSS-REFERENCE TO RELATED APPLICATION

This application claims priority from Korean Patent Application No. 10-2022-0190943, filed on Dec. 30, 2022, which is hereby incorporated by reference for all purposes as if fully set forth herein.

### BACKGROUND

### Technical Field

Embodiments of the present disclosure relate to a display device and a driving method.

### Description of Related Art

As the information society develops, demands for display devices for displaying an image are increasing in various forms. Recently, various display devices such as a liquid crystal display device and an organic light emitting display device have been used.

A display device may drive an image by displaying a plurality of frames on a display panel.

A speed at which each of the plurality of frames changes is referred to as a moving picture response time (MPRT).

As the MPRT is short, motion blur is reduced and thus the display device may display clear picture quality.

As a method for reducing the MPRT, there is a black data insertion (BDI, hereinafter referred to as “BDI driving”) technology.

For BDI driving, a period for supplying black data is additionally required, and a plurality of signal lines for BDI driving need to be additionally disposed in the display panel.

That is to say, problems may arise in that a separate BDI driving period is additionally required and the configuration of the display device is complicated because the signal lines for BDI driving should be additionally disposed.

### BRIEF SUMMARY

Various embodiments of the present disclosure are directed to providing a display device and a driving method thereof, capable of efficiently improving a moving picture response time.

Various embodiments of the present disclosure are directed to providing a display device and a driving method, capable of low-power driving by efficiently improving a moving picture response time.

Embodiments of the present disclosure may provide a display device, wherein a plurality of subpixels electrically connected to a plurality of gate lines, a plurality of data lines and a plurality of reference voltage lines are disposed, wherein a first subpixel is electrically connected to a first data line and a first reference voltage line, wherein a second subpixel is electrically connected to the first data line and a second reference voltage line different from the first reference voltage line, and wherein magnitudes of a voltage supplied to the first reference voltage line and a voltage supplied to the second reference voltage line are different from each other.

Embodiments of the present disclosure may provide a method for driving a display device in which a plurality of subpixels electrically connected to a plurality of gate lines, a plurality of data lines and a plurality of reference voltage lines are disposed, the method including: first sub frame driving step in which a first reference voltage is supplied to a first reference voltage line electrically connected to a first subpixel and a second reference voltage is supplied to a second reference voltage line electrically connected to a second subpixel; and second sub frame driving step in which the second reference voltage is supplied to the first reference voltage line and the first reference voltage is supplied to the second reference voltage line.

According to the embodiments of the present disclosure, it is possible to provide a display device and a driving method, capable of efficiently improving a moving picture response time.

According to the embodiments of the present disclosure, it is possible to provide a display device and a driving method, capable of low-power driving by efficiently improving a moving picture response time.

### DESCRIPTION OF THE SEVERAL VIEWS OF THE DRAWINGS

The above and other objects, features, and advantages of the present disclosure will be more clearly understood from the following detailed description, taken in conjunction with the accompanying drawings, in which:

FIG. 1 is a configuration diagram of a display device in accordance with embodiments of the present disclosure;

FIG. 2 is an equivalent circuit diagram of a subpixel of a display device in accordance with embodiments of the present disclosure;

FIG. 3 is a diagram illustrating black data insertion driving of a display device in accordance with embodiments of the present disclosure;

FIG. 4 is a diagram illustrating the circuit structure of subpixels disposed in a display panel in accordance with a first embodiment of the present disclosure;

FIG. 5 is a diagram illustrating driving of the display panel in accordance with the first embodiment of the present disclosure;

FIG. 6 is a diagram illustrating driving timing of a display device in accordance with the first embodiment of the present disclosure;

FIG. 7 is a diagram illustrating the circuit structure of subpixels disposed in a display panel in accordance with a second embodiment of the present disclosure;

FIG. 8 is a diagram illustrating driving of the display panel in accordance with the second embodiment of the present disclosure;

FIG. 9 is a diagram illustrating driving timing of a display device in accordance with the second embodiment of the present disclosure;

FIG. 10 is a diagram illustrating the circuit structure of subpixels disposed in a display panel in accordance with a third embodiment of the present disclosure;

FIG. 11 is a diagram illustrating driving of the display panel in accordance with the third embodiment of the present disclosure;

FIG. 12 is a diagram illustrating driving timing of a display device in accordance with the third embodiment of the present disclosure;

FIG. 13 is a diagram illustrating the circuit structure of subpixels disposed in a display panel in accordance with a fourth embodiment of the present disclosure;

FIG. 14 is a diagram illustrating driving of the display panel in accordance with the fourth embodiment of the present disclosure;

FIG. 15 is a diagram illustrating driving timing of a display device in accordance with the fourth embodiment of the present disclosure;

FIG. 16 is a flowchart showing a method for driving a display device in accordance with embodiments of the present disclosure.

FIG. 17 is a flowchart showing a process in which a subpixel emits light, in accordance with embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including,” “having,” “containing,” “constituting,” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the present disclosure will be described in detail with reference to accompanying drawings.

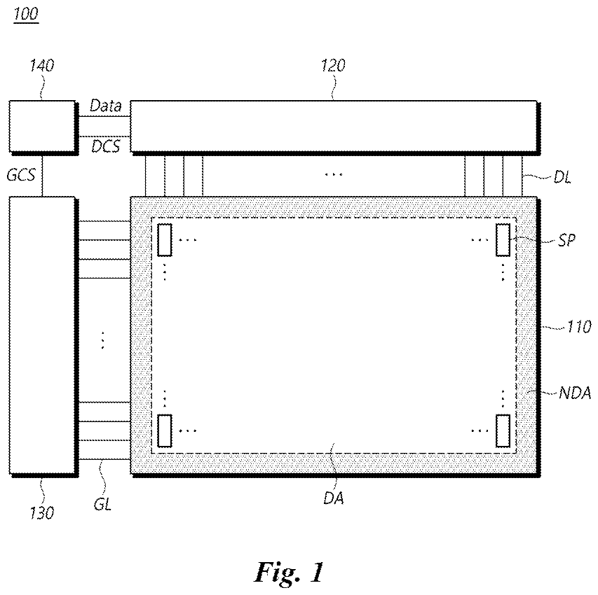

FIG. 1 is a system configuration diagram of a display device 100 in accordance with embodiments of the present disclosure.

Referring to FIG. 1, the display device 100 in accordance with the embodiments of the present disclosure may include a display panel 110 and a driving circuit for driving the display panel 110.

The display panel 110 may include signal lines such as a plurality of data lines DL and a plurality of gate lines GL, and may include a plurality of subpixels SP. The display panel 110 may include a display area DA where an image is displayed and a non-display area NDA where an image is not displayed. In the display panel 110, the plurality of subpixels SP for displaying an image may be disposed in the display area DA, and, in the non-display area NDA, driving circuits 120, 130 and 140 may be electrically connected or mounted and pad parts to which integrated circuits or printed circuits are connected may be disposed.

The driving circuit may include a data driving circuit 120 and a gate driving circuit 130, and may further include a controller 140 which controls the data driving circuit 120 and the gate driving circuit 130.

The data driving circuit 120 as a circuit for driving the plurality of data lines DL may supply data signals to the plurality of data lines DL. The gate driving circuit 130 as a circuit for driving the plurality of gate lines GL may supply gate signals to the plurality of gate lines GL.

The gate driving circuit 130 may output a gate signal of a turn-on level voltage or a gate signal of a turn-off level voltage under the control of the controller 140. By sequentially supplying gate signals of turn-on level voltages to the plurality of gate lines GL, the gate driving circuit 130 may sequentially drive the plurality of gate lines GL.

In order to control the operation timing of the data driving circuit 120, the controller 140 may supply a data control signal DCS to the data driving circuit 120. The controller 140 may supply a gate control signal GCS for controlling the operation timing of the gate driving circuit 130 to the gate driving circuit 130.

The controller 140 may start a scan according to a timing implemented in each frame, may convert input image data inputted from the outside to be suitable for a data signal format used in the data driving circuit 120 and supply converted image data Data to the data driving circuit 120, and may control driving of data at a proper time corresponding to the scan.

In order to control the data driving circuit 120 and the gate driving circuit 130, the controller 140 receives timing signals such as a vertical synchronization signal Vsync, a horizontal synchronization signal Hsync, an input data enable signal DE and a clock signal CLK, generates the various control signals DCS and GCS, and outputs the various control signals DCS and GCS to the data driving circuit 120 and the gate driving circuit 130.

The controller 140 may be implemented as a component separate from the data driving circuit 120, or may be implemented as an integrated circuit by being integrated with the data driving circuit 120.

The data driving circuit 120 receives the image data Data from the controller 140, and supplies data voltages to the plurality of data lines DL, thereby driving the plurality of data lines DL.

The data driving circuit 120 is also referred to as a source driving circuit. Such a data driving circuit 120 may include at least one source driver integrated circuit (SDIC). Each SDIC may include a shift register, a latch circuit, a digital-to-analog converter (DAC), an output buffer, and so forth. As the case may be, each SDIC may further include an analog-to-digital converter (ADC).

For example, each SDIC may be connected to the display panel 110 in a tape automated bonding (TAB) method, may be connected to bonding pads of the display panel 110 in a chip-on-glass (COG) or chip-on-panel (COP) method, or may be connected to the display panel 110 by being implemented in a chip-on-film (COF) method.

The gate driving circuit 130 may be connected to the display panel 110 in a tape automated bonding (TAB) method, may be connected to bonding pads of the display panel 110 in a chip-on-glass (COG) or chip-on-panel (COP) method, or may be connected to the display panel 110 according to a chip-on-film (COF) method. Alternatively, the gate driving circuit 130 may be formed in the non-display area NDA of the display panel 110 in a gate-in-panel (GIP) type.

When a specific gate line GL is opened by the gate driving circuit 130, the data driving circuit 120 may convert image data Data received from the controller 140 into data voltages of an analog form, and may supply the data voltages to the plurality of data lines DL.

The data driving circuit 120 may be connected to one side (e.g., the top side or the bottom side) of the display panel 110. Depending on a driving method, a panel design method, etc., the data driving circuit 120 may be connected to both sides (e.g., the top side and the bottom side) of the display panel 110, or may be connected to at least two sides of the four sides of the display panel 110.

The gate driving circuit 130 may be connected to one side (e.g., the left side or the right side) of the display panel 110. Depending on a driving method, a panel design method, etc., the gate driving circuit 130 may be connected to both sides (e.g., the left side and the right side) of the display panel 110, or may be connected to at least two sides of the four sides of the display panel 110.

The controller 140 may be a timing controller which is used in a typical display technology, may be a control device which includes a timing controller and further performs other control functions, may be a control device which is different from a timing controller, or may be a circuit in a control device. The controller 140 may be implemented by various circuits or electronic parts such as an integrated circuit (IC), a field programmable gate array (FPGA), an application specific integrated circuit (ASIC) or a processor.

The controller 140 may be mounted on a printed circuit board, a flexible printed circuit or the like, and may be electrically connected to the data driving circuit 120 and the gate driving circuit 130 through the printed circuit board, the flexible printed circuit or the like. The controller 140 may transmit and receive signals to and from the data driving circuit 120 according to at least one predetermined interface. For example, the interface may include a low voltage differential signaling (LVDS) interface, an EPI interface, a Serial Peripheral Interface (SPI), etc. The controller 140 may include a storage such as at least one register.

The display device 100 in accordance with the embodiments of the present disclosure may be a self-luminous display such as an organic light emitting diode (OLED) display, a quantum dot display or a micro light emitting diode (micro LED) display.

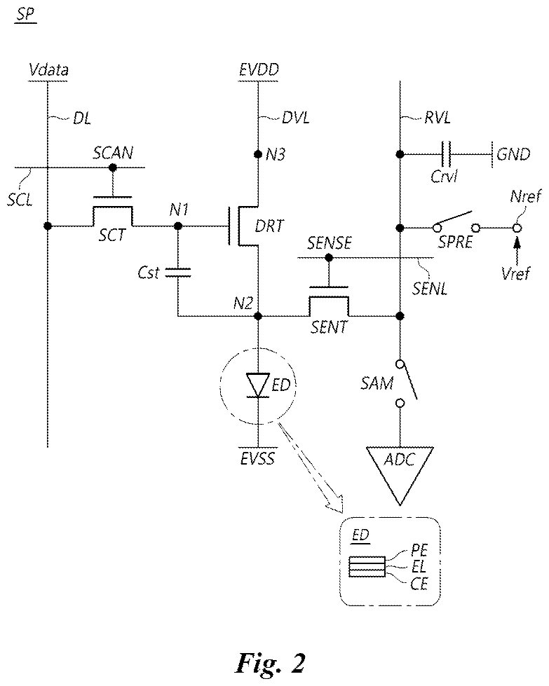

FIG. 2 is an equivalent circuit diagram of a subpixel SP of a display device 100 in accordance with embodiments of the present disclosure.

Referring to FIG. 2, each of the plurality of subpixels SP disposed in the display panel 110 of the display device 100 in accordance with the embodiments of the present disclosure may include a light emitting element ED, a driving transistor DRT, a scan transistor SCT, a sensing transistor SENT, and a storage capacitor Cst. As such, when the subpixel SP includes three transistors DRT, SCT and SENT and one capacitor Cst, the subpixel SP is referred to as having a 3T (transistor) 1C (capacitor) structure.

The light emitting element ED may include a pixel electrode PE, a common electrode CE, and a light emitting layer EL which is positioned between the pixel electrode PE and the common electrode CE. The pixel electrode PE may be disposed in each subpixel SP, and the common electrode CE may be disposed in common in a plurality of subpixels SP. For example, the pixel electrode PE may be an anode electrode, and the common electrode CE may be a cathode electrode. For another example, the pixel electrode PE may be a cathode electrode, and the common electrode CE may be an anode electrode. For example, the light emitting element ED may be an organic light emitting diode (OLED), a micro light emitting diode (micro LED) or a quantum dot light emitting element.

The driving transistor DRT as a transistor for driving the light emitting element ED may have a first node N1, a second node N2 and a third node N3.

The first node N1 of the driving transistor DRT may be a gate node of the driving transistor DRT, and may be electrically connected to a source node or a drain node of the scan transistor SCT. The second node N2 of the driving transistor DRT may be a source node or a drain node of the driving transistor DRT, may be electrically connected to a source node or a drain node of the sensing transistor SENT, and may also be electrically connected to the pixel electrode PE of the light emitting element ED. The third node N3 of the driving transistor DRT may be electrically connected to a driving voltage line DVL which supplies a driving voltage EVDD.

The scan transistor SCT may be controlled by a scan signal SCAN, and may be connected between the first node N1 of the driving transistor DRT and a data line DL. The scan transistor SCT may be turned on or off according to the scan signal SCAN supplied from a scan signal line SCL which is one kind of gate line GL, thereby controlling connection between the data line DL and the first nodes N1 of the driving transistor DRT.

The scan transistor SCT may be turned on by the scan signal SCAN having a turn-on level voltage, and thereby, may transfer a data voltage Vdata supplied from the data line DL to the first node N1 of the driving transistor DRT.

The turn-on level voltage of the scan signal SCAN capable of turning on the scan transistor SCT may be a high level voltage or a low level voltage. A turn-off level voltage of the scan signal SCAN capable of turning off the scan transistor SCT may be a low level voltage or a high level voltage. For example, when the scan transistor SCT is an n-type transistor, the turn-on level voltage may be a high level voltage and the turn-off level voltage may be a low level voltage. For another example, when the scan transistor SCT is a p-type transistor, the turn-on level voltage may be a low level voltage and the turn-off level voltage may be a high level voltage.

The sensing transistor SENT may be controlled by a sense signal SENSE, and may be connected between the second node N2 of the driving transistor DRT and a reference voltage line RVL. The sensing transistor SENT may be turned on or off according to the sense signal SENSE supplied from a sense signal line SENL which is another kind of gate line GL, thereby controlling connection between the reference voltage line RVL and the second node N2 of the driving transistor DRT.

The sensing transistor SENT may be turned on by the sense signal SENSE having a turn-on level voltage, and thereby, may transfer a reference voltage Vref supplied from the reference voltage line RVL to the second node N2 of the driving transistor DRT. The sensing transistor SENT may be turned on by the scan signal SCAN having a turn-on level voltage, and thereby, may transfer a reference voltage Vref supplied from the reference voltage line RVL to the second node N2 of the driving transistor DRT.

The turn-on level voltage of the sense signal SENSE capable of turning on the sensing transistor SENT may be a high level voltage or a low level voltage. A turn-off level voltage of the sense signal SENSE capable of turning off the sensing transistor SENT may be a low level voltage or a high level voltage. For example, when the sensing transistor SENT is an n-type transistor, the turn-on level voltage may be a high level voltage and the turn-off level voltage may be a low level voltage. For another example, when the sensing transistor SENT is a p-type transistor, the turn-on level voltage may be a low level voltage and the turn-off level voltage may be a high level voltage.

The display device 100 may further include a line capacitor Crv1 which is formed between the reference voltage line RVL and a ground GND, a sampling switch SAM which controls connection between the reference voltage line RVL and the analog-to-digital converter ADC, and a power switch SPRE which controls connection between the reference voltage line RVL and a reference voltage supply node Nref. The reference voltage Vref outputted from a power supply device may be supplied to the reference voltage supply node Nref, and may be supplied to the reference voltage line RVL through the power switch SPRE.

The sensing transistor SENT may be turned on by the sense signal SENSE having a turn-on level voltage, and thereby, may transfer a voltage V2 of the second node N2 of the driving transistor DRT to the reference voltage line RVL. Accordingly, the line capacitor Crv1 which is formed between the reference voltage line RVL and the ground GND may be charged.

The function of the sensing transistor SENT to transfer the voltage V2 of the second node N2 of the driving transistor DRT to the reference voltage line RVL may be used during a driving to sense the characteristic value of the subpixel SP. In this case, a voltage transferred to the reference voltage line RVL may be a voltage for calculating the characteristic value of the subpixel SP or a voltage on which the characteristic value of the subpixel SP is reflected.

In the present disclosure, the characteristic value of the subpixel SP may be the characteristic value of the driving transistor DRT or the light emitting element ED. The characteristic value of the driving transistor DRT may include the threshold voltage and mobility of the driving transistor DRT. The characteristic value of the light emitting element ED may include the threshold voltage of the light emitting element ED.

Each of the driving transistor DRT, the scan transistor SCT and the sensing transistor SENT may be an n-type transistor or a p-type transistor. In the present disclosure, for the sake of convenience in explanation, it is exemplified that each of the driving transistor DRT, the scan transistor SCT and the sensing transistor SENT is an n-type.

The storage capacitor Cst may be connected between the first node N1 and the second node N2 of the driving transistor DRT. The storage capacitor Cst is charged with an amount of charge corresponding to a voltage difference between both ends, and serves to maintain the voltage difference between both ends for a predetermined frame period. Accordingly, during the predetermined frame period, the corresponding subpixel SP may emit light.

The storage capacitor Cst may not be a parasitic capacitor (e.g., Cgs or Cgd) which is an internal capacitor existing between the gate node and the source node (or the drain node) of the driving transistor DRT, but may be an external capacitor which is intentionally designed outside the driving transistor DRT.

The scan signal line SCL and the sense signal line SENL may be different gate lines GL. In this case, the scan signal SCAN and the sense signal SENSE may be separate gate signals, and an on-off timing of the scan transistor SCT and an on-off timing of the sensing transistor SENT in one subpixel SP may be independent of each other. In other words, an on-off timing of the scan transistor SCT and an on-off timing of the sensing transistor SENT in one subpixel SP may be the same as or different from each other. This may be referred to as a “two-scan” structure.

Unlike this, the scan signal line SCL and the sense signal line SENL may be the same gate line GL. Namely, the gate node of the scan transistor SCT and the gate node of the sensing transistor SENT in one subpixel SP may be connected to one gate line GL. In this case, the scan signal SCAN and the sense signal SENSE may be the same gate signal, and an on-off timing of the scan transistor SCT and an on-off timing of the sensing transistor SENT in one subpixel SP may be the same as each other. In other words, the scan signal SCAN may be supplied to the gate node of the scan transistor SCT and the gate node of the sensing transistor SENT. This may be referred to as a “one-scan” structure.

The reference voltage line RVL may be disposed for each one column of subpixels SP. Unlike this, the reference voltage line RVL may be disposed for each two columns of subpixels SP. When the reference voltage line RVL is disposed for each two columns of subpixels SP, a plurality of subpixels SP may be supplied with the reference voltage Vref from one reference voltage line RVL.

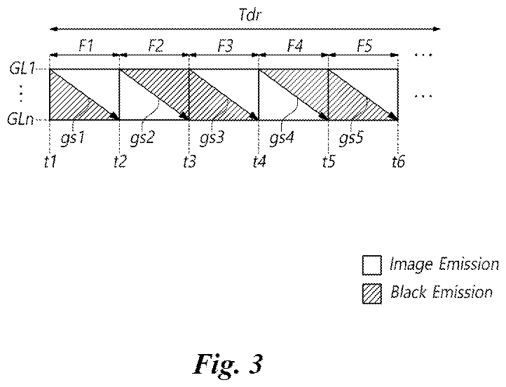

FIG. 3 is a diagram illustrating black data insertion (BDI) driving of a display device 100 in accordance with embodiments of the present disclosure.

A driving period Tdr of the display device 100 may include a plurality of frame periods for displaying an image on the display panel 110.

The plurality of frame periods may include a first frame period F1 to a fifth frame period F5.

The first frame period F1 may be a period from a first time point t1 to a second time point t2.

During the first frame period F1, gate signals may be sequentially supplied to a first gate line GL1 to an nth gate line GLn according to time. n may be a natural number of 1 or greater.

Referring to FIG. 3, a first gate signal indicator line gs1 that extends from the left upper end to the right lower end may be seen. The first gate signal indicator line gs1 indicates a position of a gate line to which a gate signal is supplied according to time.

When a gate signal is supplied to a gate line GL, an image may be displayed on the display panel 110 for a period of the same length as the first frame period F1 (image emission). The first frame period F1 may be an image driving period for displaying an image.

The second frame period F2 may be a period from the second time point t2 to a third time point t3.

During the second frame period F2, gate signals may be sequentially supplied to the first gate line GL1 to the nth gate line GLn according to time.

Referring to FIG. 3, a second gate signal indicator line gs2 that extends from the left upper end to the right lower end may be seen. The second gate signal indicator line gs2 indicates a position of a gate line to which a gate signal is supplied according to time.

When a gate signal is supplied to a gate line GL, a black image may be displayed on the display panel 110 for a period of the same length as the second frame period F2 (black emission). Display of a black image (black emission) may be performed as a data voltage Vdata for displaying a low grayscale is supplied to the plurality of data lines DL. For example, the display of a black image (black emission) may be the display of a black or gray image. The second frame period F2 may be a BDI driving period for black data insertion (BDI).

The third frame period F3 may be a period from the third time point t3 to a fourth time point t4, and the characteristics of the third frame period F3 may be the same as the characteristics of the first frame period F1. The fourth frame period F4 may be a period from the fourth time point t4 to a fifth time point t5, and the characteristics of the fourth frame period F4 may be the same as the characteristics of the second frame period F2. The fifth frame period F5 may be a period from the fifth time point t5 to a sixth time point t6, and the characteristics of the fifth frame period F5 may be the same as the characteristics of the first frame period F1.

Namely, an odd-numbered frame period F2i-1 (i is a natural number) may be an image driving period whose characteristics are the same as the characteristics of the first frame period F1, and an even-numbered frame period F2i (i is a natural number) may be a BDI driving period whose characteristics are the same as the characteristics of the second frame period F2.

After display of an image (image emission) is performed during the odd-numbered frame period F2i-1, display of a black image (black emission) may be performed during the even-numbered frame period F2i. In order to display a black image, the data voltage Vdata for displaying a low grayscale may be charged in the storage capacitor Cst. That is to say, the storage capacitor Cst may be initialized to the data voltage Vdata for displaying a low grayscale.

Through the initialization of the storage capacitor Cst, a moving picture response time (MPRT) may be improved. However, in order to initialize the storage capacitor Cst, a problem may arise in that BDI driving periods should be added. In addition, because signal lines for BDI driving need to be additionally disposed, a problem may arise in that the configuration of the display device 100 or the display panel 110 is complicated.

Embodiments of the present disclosure may provide a display device 100 and a driving method thereof, capable of efficiently improving a moving picture response time (MPRT).

Embodiments of the present disclosure may provide a display device 100 and a driving method thereof, capable of low-power driving by efficiently improving a moving picture response time (MPRT).

Embodiments of the present disclosure will be described below in detail.

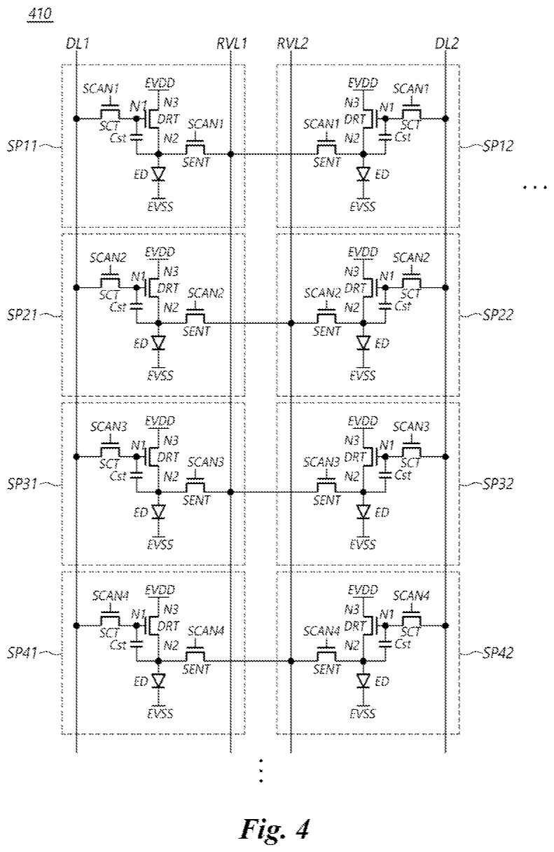

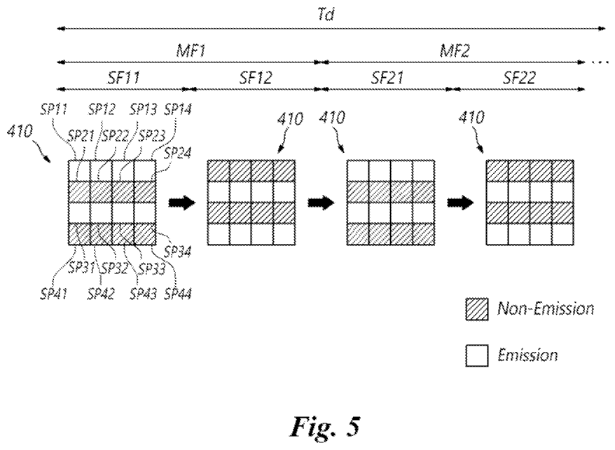

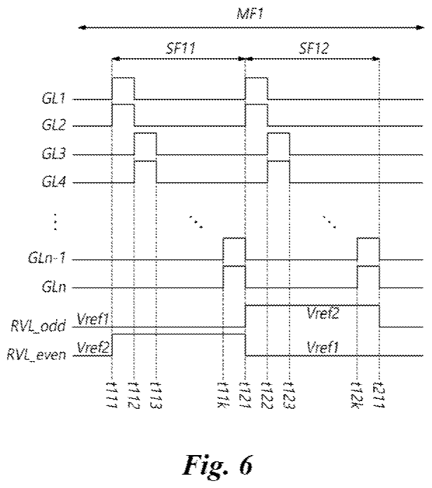

FIG. 4 is a diagram illustrating the circuit structure of subpixels SP disposed in a display panel 410 in accordance with a first embodiment of the present disclosure. FIG. 5 is a diagram illustrating driving of the display panel 410 in accordance with the first embodiment of the present disclosure. FIG. 6 is a diagram illustrating driving timing of a display device 100 in accordance with the first embodiment of the present disclosure.

In a display panel 410, a plurality of data lines DL, a plurality of reference voltage lines RVL, a plurality of gate lines GL and a plurality of subpixels SP may be disposed.

The plurality of subpixels SP may include an xyth subpixel SPxy. x may be a row in which a subpixel SP is disposed, and y may be a column in which the subpixel SP is disposed. Hereinafter, a subpixel SP may be defined in the form of an xyth subpixel SPxy. Referring to FIG. 4, the plurality of subpixels SP may include an 11th subpixel SP11 to a 42nd subpixel SP42. Although a plurality of subpixels SP are disposed in the display panel 410, for the sake of convenience in explanation, the characteristics of the plurality of subpixels SP will be described by taking the 11th subpixel SP11 to the 42nd subpixel SP42 as an example.

Each of the plurality of subpixels SP may include elements such as a driving transistor DRT, a scan transistor SCT, a sensing transistor SENT, a light emitting element ED and a storage capacitor Cst, which is the same as the characteristics of the subpixel SP illustrated in FIG. 2.

Referring to FIG. 4, the plurality of data lines DL may include a first data line DL1 and a second data line DL2.

Referring to FIG. 4, the plurality of reference voltage lines RVL may include a first reference voltage line RVL1 and a second reference voltage line RVL2. The plurality of reference voltage lines RVL may be classified into an odd-numbered reference voltage line RVL2a-1 (a is a natural number) (hereinafter denoted as “RVL_odd”) and an even-numbered reference voltage line RVL2a (a is a natural number) (hereinafter denoted as “RVL_even”) on the basis of an order in which the plurality of reference voltage lines RVL are disposed. The first reference voltage line RVL1 may be included in the odd-numbered reference voltage line RVL_odd, and the second reference voltage line RVL2 may be included in the even-numbered reference voltage line RVL_even.

The first data line DL1 may be electrically connected to the 11th subpixel SP11, the 21st subpixel SP21, the 31st subpixel SP31 and the 41st subpixel SP41. The first data line DL1 may be electrically connected to the scan transistor SCT of each of the 11th subpixel SP11, the 21st subpixel SP21, the 31st subpixel SP31 and the 41st subpixel SP41.

The second data line DL2 may be electrically connected to the 12th subpixel SP12, the 22nd subpixel SP22, the 32nd subpixel SP32 and the 42nd subpixel SP42. The second data line DL2 may be electrically connected to the scan transistor SCT of each of the 12th subpixel SP12, the 22nd subpixel SP22, the 32nd subpixel SP32 and the 42nd subpixel SP42.

The first reference voltage line RVL1 may be electrically connected to the 11th subpixel SP11, the 12th subpixel SP12, the 31st subpixel SP31 and the 32nd subpixel SP32. The first reference voltage line RVL1 may be electrically connected to the sensing transistor SENT of each of the 11th subpixel SP11, the 12th subpixel SP12, the 31st subpixel SP31 and the 32nd subpixel SP32.

The second reference voltage line RVL2 may be electrically connected to the 21st subpixel SP21, the 22nd subpixel SP22, the 41st subpixel SP41 and the 42nd subpixel SP42. The second reference voltage line RVL2 may be electrically connected to the sensing transistor SENT of each of the 21st subpixel SP21, the 22nd subpixel SP22, the 41st subpixel SP41 and the 42nd subpixel SP42.

A first reference voltage Vref1 or a second reference voltage Vref2 may be supplied to the first reference voltage line RVL1. The first reference voltage Vref1 or the second reference voltage Vref2 may be supplied to the second reference voltage line RVL2.

When the first reference voltage Vref1 is supplied to the first reference voltage line RVL1, the second reference voltage Vref2 may be supplied to the second reference voltage line RVL2. When the second reference voltage Vref2 is supplied to the first reference voltage line RVL1, the first reference voltage Vref1 may be supplied to the second reference voltage line RVL2.

The magnitude of the second reference voltage Vref2 may be larger than the magnitude of the first reference voltage Vref1.

The magnitude of the second reference voltage Vref2 may be larger than the magnitude of a data voltage Vdata supplied to the data line DL. Alternatively, the magnitude of the second reference voltage Vref2 may be the same as the magnitude of the data voltage Vdata supplied to the data line DL.

A first scan signal SCAN1 may be supplied to the 11th subpixel SP11 and the 12th subpixel SP12 through a first gate line GL1, and may be supplied to the gate nodes of the scan transistors SCT and the sensing transistors SENT. A second scan signal SCAN2 may be supplied to the 21st subpixel SP21 and the 22nd subpixel SP22 through a second gate line GL2, and may be supplied to the gate nodes of the scan transistors SCT and the sensing transistors SENT. A third scan signal SCAN3 may be supplied to the 31st subpixel SP31 and the 32nd subpixel SP32 through a third gate line GL3, and may be supplied to the gate nodes of the scan transistors SCT and the sensing transistors SENT. A fourth scan signal SCAN4 may be supplied to the 41st subpixel SP41 and the 42nd subpixel SP42 through a fourth gate line GL4, and may be applied to the gate nodes of the scan transistors SCT and the sensing transistors SENT.

That is to say, the plurality of subpixels SP may be driven in a “one-scan” structure. However, the present disclosure is not limited thereto, and as a sense signal SENSE is supplied to the sensing transistor SENT, the scan transistor SCT and the sensing transistor SENT may be individually controlled.

For each two columns in which subpixels SP are disposed, an odd-numbered reference voltage line RVL_odd and an even-numbered reference voltage line RVL_even as two reference voltage lines may be disposed. When considering, as one unit, four subpixels SP adjacent to one another in longitudinal and transverse directions, two subpixels SP adjacent to each other in the transverse direction may be electrically connected to an odd-numbered reference voltage line RVL_odd, and the remaining two subpixels SP adjacent to each other in the transverse direction may be electrically connected to an even-numbered reference voltage line RVL_even.

For each one column in which subpixels SP are disposed, an odd-numbered reference voltage line RVL_odd and an even-numbered reference voltage line RVL_even as two reference voltage lines may be disposed. When considering, as one unit, two subpixels SP adjacent to each other in a longitudinal direction, one subpixel SP may be electrically connected to an odd-numbered reference voltage line RVL_odd, and the remaining one subpixel SP may be electrically connected to an even-numbered reference voltage line RVL_even.

The characteristics of the plurality of subpixels SP disposed in the display panel 410 have been described, and a method in which subpixels SP emit light will be described below. The following description is an example, and a method for driving a display device 100 is not limited hereto.

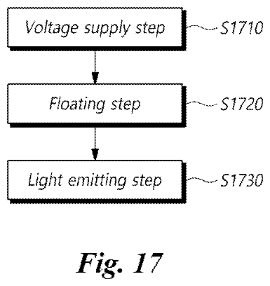

FIG. 17 is a flowchart showing a process in which a subpixel SP emits light, in accordance with embodiments of the present disclosure. Referring to FIG. 17, the process in which a subpixel SP emits light may be performed as voltage supply step S1710, floating step S1720 and light emitting step S1730.

The voltage supply step S1710 may be step in which voltages are supplied to a first node N1 as the gate node of the driving transistor DRT included in the subpixel SP and a second node N2 as the source node of the driving transistor DRT. The data voltage Vdata may be supplied to the first node N1, and a reference voltage Vref may be supplied to the second node N2. Voltages supplied to the first node N1 and the second node N2 may be stored in the storage capacitor Cst. A voltage stored in the storage capacitor Cst may be a gate-source voltage Vgs. As the gate-source voltage Vgs is stored in the storage capacitor Cst, even after the voltage supply step S1710, the voltage difference between the gate node N1 and the source node N2 of the driving transistor DRT may be maintained as the gate-source voltage Vgs. The floating step S1720 may be performed after the voltage supply step S1710.

The data voltage Vdata supplied in the voltage supply step S1710 may be a voltage of 0[V] to 16[V]. The reference voltage Vref supplied in the voltage supply step S1710 may be a voltage of 0[V] to 0.5[V]. Due to the voltage difference between the data voltage Vdata and the reference voltage Vref, the magnitude of a driving current Ids flowing through the driving transistor DRT may be adjusted. As the magnitude of the driving current Ids is adjusted, the luminance of the light emitting element ED may be adjusted. However, the above-described voltage magnitudes are nothing but a mere example, and may be changed according to a design.

The reference voltage Vref supplied in the voltage supply step S1710 may be a voltage of 0[V] to 0.5[V], and may be supplied to the anode electrode of the light emitting element ED. A base voltage EVSS may be supplied to the cathode electrode of the light emitting element ED. The base voltage EVSS may be a ground voltage GND. A voltage difference between the anode electrode and the cathode electrode of the light emitting element ED is lower than a threshold voltage Vth_ED of the light emitting element ED. Accordingly, no current may flow through the light emitting element ED, and the light emitting element ED does not emit light in the voltage supply step S1710.

The floating step S1720 may be step in which the voltage of the second node N2 rises. In the floating step S1720, the scan transistor SCT and the sensing transistor SENT may be switched to a turn-off state. In other words, as no voltage is supplied to the first node N1 and the second node N2, the voltage of the first node N1 and the voltage of the second node N2 may become floating states.

During the voltage supply step S1710, since the gate-source voltage Vgs is stored in the storage capacitor Cst, the driving transistor DRT is in a turn-on state. Accordingly, during the floating step S1720, the driving current Ids may flow through the driving transistor DRT. The driving current Ids may flow from a third node N3, which is a drain node of the driving transistor DRT, to the second node N2, which is the source node of the driving transistor DRT. As the driving current Ids flows to the second node N2, the voltage of the second node N2 rises. At this time, a voltage across the storage capacitor Cst is maintained as the charged gate-source voltage Vgs. Therefore, when the voltage of the second node N2 rises, the voltage of the first node N1 may also rise.

In the plurality of subpixels SP, a driving voltage EVDD may be supplied to the third node N3, and the base voltage EVSS may be supplied to the cathode electrode of the light emitting element ED. Between the third node N3 and a node to which the cathode electrode is connected, a voltage obtained by subtracting the base voltage EVSS from the driving voltage EVDD is applied. Since the scan transistor SCT and the sensing transistor SENT are turned off in the floating step S1720, a voltage obtained by subtracting the base voltage EVSS from the driving voltage EVDD is distributed and applied to the driving transistor DRT and the light emitting element ED.

When the floating step S1720 starts, a voltage obtained by subtracting the base voltage EVSS from the driving voltage EVDD is applied between the third node N3 and the second node N2 of the driving transistor DRT. Since a voltage corresponding to a difference between the reference voltage Vref and the base voltage EVSS is applied to the light emitting element ED, a voltage close to 0V may be applied to the light emitting element ED. In other words, when the floating step S1720 starts, a voltage lower than the threshold voltage Vth+ED of the light emitting element ED may be applied to the light emitting element ED.

While the floating step S1720 proceeds, the voltage of the second node N2 rises. The voltage of the third node N3 is the driving voltage EVDD, and the voltage of the second node N2 rises. Accordingly, the magnitude of a voltage applied across the driving transistor DRT decreases.

Conversely, while the floating step S1720 proceeds, a voltage across the light emitting element ED may rise. Since the base voltage EVSS of the light emitting element ED is maintained and the voltage of the second node N2 connected to the anode electrode rises, a voltage across the light emitting element ED may rise. While a voltage across the light emitting element ED rises, the voltage across the light emitting element ED may become higher than the threshold voltage Vth_ED of the light emitting element ED. From this time, the light emitting element ED becomes a state capable of emitting light. A luminance at which the light emitting element ED emits light corresponds to the magnitude of the driving current Ids. The voltage of the second node N2 rises to a voltage corresponding to the driving current Ids. For example, the voltage of the second node N2 may rise to a “driving point of a light emitting element” where the I-V curve of a driving transistor and the I-V curve of the light emitting element meet with each other.

After the floating step S1720 proceeds, the light emitting step S1730 may proceed. In the light emitting step S1730, the light emitting element ED may emit light at a predetermined luminance. The predetermined luminance of the light emitting element ED is controlled by the driving current Ids. The light emitting element ED may emit light when a forward voltage is applied across the light emitting element ED. However, due to the characteristics of the light emitting element ED, the light emitting element ED cannot efficiently emit light only by the fact that a forward voltage is applied across the light emitting element ED, and as the light emitting element ED emits light inefficiently, it may be difficult to control the light emitting element ED. The light emitting element ED may be easily controlled only when current is supplied as electrons and holes are coupled. In other words, the light emitting element ED may be efficiently controlled by being supplied with the driving current Ids.

Even in the subpixel SP of the present disclosure, the voltage supply step S1710, the floating step S1720 and the light emitting step S1730 described above may proceed.

In the voltage supply step S1710, the plurality of subpixels SP may be supplied with the data voltage Vdata through the data line DL, and the data voltage Vdata may be supplied to the first node N1 being the gate node of the driving transistor DRT.

In the voltage supply step S1710, when the first reference voltage Vref1 is supplied to odd-numbered reference voltage lines RVL_odd, the second reference voltage Vref2 may be supplied to even-numbered reference voltage lines RVL_even. The first reference voltage Vref1 may be lower than the second reference voltage Vref2.

The storage capacitor Cst included in the subpixel SP which is supplied with the data voltage Vdata and the first reference voltage Vref1 may be charged with a voltage for displaying a frame image.

On the other hand, the storage capacitor Cst included in the subpixel SP which is supplied with the data voltage Vdata and the second reference voltage Vref2 may not be charged with a voltage or may be charged with a voltage which is not a voltage for displaying a frame image. In order to display an image, the data voltage Vdata should be supplied to the first node N1, and the reference voltage Vref should be supplied to the second node N2. At this time, the data voltage Vdata is higher than the reference voltage Vref. Unlike this, the second reference voltage Vref2 has the same magnitude as the data voltage Vdata, or has a voltage higher than the data voltage Vdata. For example, when the second reference voltage Vref2 is the same as or higher than the data voltage Vdata, the subpixel SP supplied with the second reference voltage Vref2 may not emit light. In this case, the subpixel SP may display a grayscale value of 0. As some subpixels SP among the plurality of subpixels SP emit light with a grayscale value of 0, the display device 100 may be driven by a BDI driving method.

The second reference voltage Vref2 may be higher than the first reference voltage Vref1 but lower than the data voltage Vdata. In this case, the subpixel SP may emit light with a low grayscale. The low grayscale may be a gray color. BDI driving may be performed by using a low grayscale even though a black grayscale is not used. Namely, as some subpixels SP among the plurality of subpixels SP emit light with a low grayscale, the display device 100 may be driven by the BDI driving method. This also belongs to BDI driving, but may also be referred to as “GDI (gray data insertion) driving.” A moving picture response time (MPRT) may also be efficiently improved even through the “GDI driving.”

The second reference voltage Vref2 may be a second-first reference voltage Vref2-1 or a second-second reference voltage Vref2-2. A case where the second-first reference voltage Vref2-1 is supplied to a subpixel and a case where the second-second reference voltage Vref2-2 is supplied to a subpixel will be separately described.

The second-first reference voltage Vref2-1 may be a voltage which is higher than the first reference voltage Vref1 but is lower than the threshold voltage Vth_ED of the light emitting element ED. Since the second-first reference voltage Vref2-1 is lower than the threshold voltage Vth_ED of the light emitting element ED, the light emitting element ED may be in a turn-off state. For example, assuming that the threshold voltage Vth_ED of the light emitting element ED is 7.5[V], the second-first reference voltage Vref2-1 may be 0.5[V] to 7.5[V]. The data voltage Vdata may have, for example, a voltage of 0[V] to 16[V], and the second-first reference voltage Vref2-1 may be higher than the data voltage Vdata but may be lower than the data voltage Vdata.

When the second-first reference voltage Vref2-1 is higher than the data voltage Vdata, the storage capacitor Cst is not charged with a voltage for displaying a frame image. Accordingly, the subpixel SP does not emit light. Through this, BDI driving is possible.

When the second-first reference voltage Vref2-1 is lower than the data voltage Vdata, the storage capacitor Cst may be charged with a gate-source voltage Vgs. In this case, the driving current Ids may flow, and a voltage across the light emitting element ED may be higher than the threshold voltage Vth_ED during a floating period. However, since the gate-source voltage Vgs is small, even though the driving current Ids flows through the light emitting element ED, the luminance of the light emitting element ED may be a low grayscale. In other words, since the subpixel SP emits light with a low grayscale, through this, BDI driving or GDI driving is possible.

The second-second reference voltage Vref2-2 may be a voltage which is higher than the first reference voltage Vref1 and is higher than the threshold voltage Vth_ED of the light emitting element ED. Since the second-second reference voltage Vref2-2 is higher than the threshold voltage Vth_ED of the light emitting element ED, the light emitting element ED may be in a turn-on state. However, since a voltage across the storage capacitor Cst is not charged with a voltage for displaying a frame image, the driving current Ids does not flow through the light emitting element ED. As described above, the light emission of the light emitting element ED is not controlled although a voltage the same as or higher than the threshold voltage Vth_ED is supplied across the light emitting element ED. The light emitting element ED may emit light by controlling the driving current Ids flowing through the light emitting element ED. Namely, since the electron-hole coupling efficiency of the subpixel SP supplied with the second-second reference voltage Vref2-2 is very low, the subpixel SP emits light with a low grayscale. BDI driving or GDI driving is possible using subpixels SP which emit light with low grayscales.

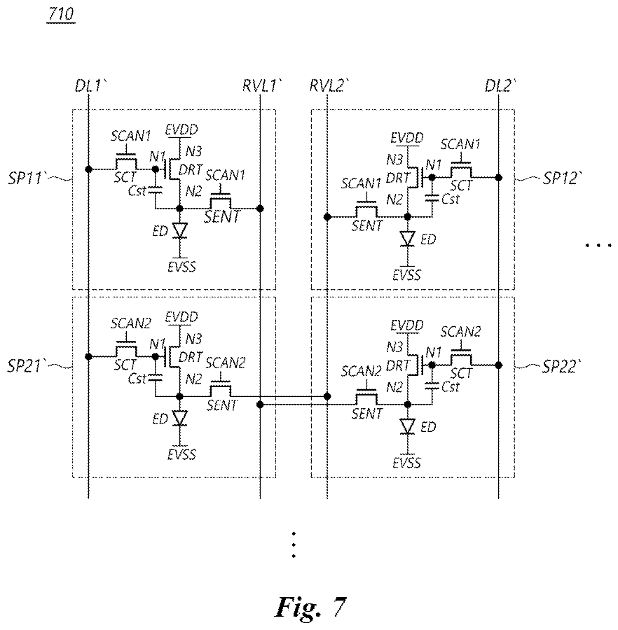

Summarizing the foregoing, as the second reference voltage Vref2 is supplied to the subpixel SP, the subpixel SP may emit light with a black grayscale or a low grayscale, and accordingly, BDI driving or GDI driving is possible. The second reference voltage Vref2 may be the second-first reference voltage Vref2-1 or the second-second reference voltage Vref2-2. Embodiments of the present disclosure include first to fourth embodiments. In the first and second embodiments of the present disclosure, the second reference voltage Vref2 may be the second-first reference voltage Vref2-1 or the second-second reference voltage Vref2-2. The first embodiment will be described with reference to FIGS. 4 to 6. The second embodiment will be described with reference to FIGS. 7 to 9. Hereinafter, the first embodiment and second embodiment will be described in detail.

As described above with reference to FIG. 4, the display device 100 according to the first embodiment of the present disclosure may include the display panel 410. Driving of the display panel 410 including subpixels SP will be described below.

Referring to FIG. 5, the driving period Td of the display device 100 may include a plurality of main frame periods MF for displaying an image from the display panel 410.

The plurality of main frame periods MF may include a first main frame period MF1 and a second main frame period MF2.

Referring to FIG. 5, the first main frame period MF1 during which the plurality of subpixels SP emit light may include an 11th sub frame period SF11 and a 12th sub frame period SF12.

Referring to FIG. 5, whether the display panel 410 emits light may be checked, and for the sake of convenience in explanation, it is illustrated that only an 11th subpixel SP11 to a 44th subpixel SP44 are disposed in the display panel 410. The number of subpixels SP disposed in the display panel 410 is not limited.

The 11th sub frame period SF11 may be a period in which some subpixels SP among the plurality of subpixels SP are in an emission state. Some subpixels SP may be the 11th subpixel SP11, the 12th subpixel SP12, the 13th subpixel SP13, the 14th subpixel SP14, the 31st subpixel SP31, the 32nd subpixel SP32, the 33rd subpixel SP33 and the 34th subpixel SP34 which are subpixels SP connected to an odd-numbered reference voltage line RVL_odd. That is to say, some subpixels SP may be subpixels SP which are electrically connected to an odd-numbered reference voltage line RVL_odd.

The 12th sub frame period SF12 may be a period in which remaining subpixels SP except the some subpixels SP among the plurality of subpixels SP are in an emission state. Remaining subpixels SP may be the 21st subpixel SP21, the 22nd subpixel SP22, the 23rd subpixel SP23, the 24th subpixel SP24, the 41st subpixel SP41, the 42nd subpixel SP42, the 43rd subpixel SP43 and the 44th subpixel SP44 which are subpixels SP connected to an even-numbered reference voltage line RVL_even. That is to say, remaining subpixels SP may be subpixels SP which are electrically connected to an even-numbered reference voltage line RVL_even.

In the 11th sub frame period SF11, only the some subpixels SP may be in an emission state, and the remaining subpixels SP may be in a non-emission state. Since the remaining subpixels SP are in a non-emission state, storage capacitors Cst included in the remaining subpixels SP may be initialized. In other words, since the remaining subpixels SP may be subpixels SP which are electrically connected to an even-numbered reference voltage line RVL_even, the storage capacitors Cst included in the remaining subpixels SP may be initialized during the 11th sub frame period SF11.

In the 12th sub frame period SF12, only the remaining subpixels SP may be in an emission state, and the some subpixels SP may be in a non-emission state. Since the some subpixels SP are in a non-emission state, storage capacitors Cst included in the some subpixels SP may be initialized. In other words, since the some subpixels SP may be subpixels SP which are electrically connected to an odd-numbered reference voltage line RVL_odd, the storage capacitors Cst included in the some subpixels SP may be initialized during the 12th sub frame period SF12.

Namely, during the first main frame period MF1 for displaying one frame image, storage capacitors Cst included in all subpixels SP undergo an initialization process, and thus, a moving picture response time (MPRT) may be improved.

After the first main frame period MF1, the second main frame period MF2 may proceed. The second main frame period MF2 may include a 21st sub frame period SF21 and a 22nd sub frame period SF22. The characteristics of the 21st sub frame period SF21 may be the same as those of the 11th sub frame period SF11, and the characteristics of the 22nd sub frame period SF22 may be the same as those of the 12th sub frame period SF12.

After the second main frame period MF2, a plurality of main frame periods MF may repeatedly proceed.

Following the above description of driving of the display panel 410, a method for driving the display device 100 will be described below in detail with reference to FIG. 6 being a timing diagram of signals.

Referring to FIG. 6, signals supplied to a first gate line GL1 to an nth gate line GLn included in the display device 100 and time points at which the signals are supplied may be checked. The display device 100 may include the plurality of reference voltage lines RVL, and the plurality of reference voltage lines RVL may be classified into an odd-numbered reference voltage line RVL_odd and an even-numbered reference voltage line RVL_even on the basis of an order in which the plurality of reference voltage lines RVL are disposed.

The first reference voltage Vref1 or the second reference voltage Vref2 may be supplied to the odd-numbered reference voltage line RVL_odd. The first reference voltage Vref1 or the second reference voltage Vref2 may be supplied to the even-numbered reference voltage line RVL_even. The magnitude of the second reference voltage Vref2 may be larger than the magnitude of the first reference voltage Vref1. The second reference voltage Vref2 may be the second-first reference voltage Vref2-1 or the second-second reference voltage Vref2-2.

Referring to FIG. 6, the first main frame period MF1 during which the plurality of subpixels SP emit light may include the 11th sub frame period SF11 and the 12th sub frame period SF12.

The 11th sub frame period SF11 may be a period in which the first reference voltage Vref1 is supplied to the odd-numbered reference voltage line RVL_odd and the second reference voltage Vref2 is supplied to the even-numbered reference voltage line RVL_even.

The 12th sub frame period SF12 may be a period in which the second reference voltage Vref2 is supplied to the odd-numbered reference voltage line RVL_odd and the first reference voltage Vref1 is supplied to the even-numbered reference voltage line RVL_even.

The emission state of a subpixel SP may vary depending on whether or not the light emitting element ED included in the subpixel SP emits light or a luminance of light emission. Whether or not the light emitting element ED included in the subpixel SP emits light or a luminance of light emission may vary depending on the data voltage Vdata supplied to the first node N1 and the reference voltage Vref supplied to the second node N2. When the data voltage Vdata is higher than the reference voltage Vref, an image may be displayed. When the data voltage Vdata is lower than the reference voltage Vref, the driving transistor DRT does not flow the driving current Ids, and thus, the light emitting element ED may be maintained in a non-emission state.

Referring to FIG. 6, in a period between a 111th time point t111 and a 112th time point t112, turn-on gate signals may be supplied to the first gate line GL1 and the second gate line GL2 at the 111th time point t111 as the same time point, and may be maintained.

In the period between the 111th time point t111 and the 112th time point t112, the data voltage Vdata may be supplied through the plurality of data lines DL to subpixels SP electrically connected to the first gate line GL1 and subpixels SP electrically connected to the second gate line GL2. For example, the same data voltage Vdata may be supplied to the 11th subpixel SP11 electrically connected to the first gate line GL1 and the 21st subpixel SP21 electrically connected to the second gate line GL2.

The period between the 111th time point t111 and the 112th time point t112 may be a period in which the first reference voltage Vref1 is supplied to an odd-numbered reference voltage line RVL_odd and the second reference voltage Vref2 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

Referring to FIG. 4, the subpixels SP electrically connected to the first gate line GL1 may be electrically connected to the odd-numbered reference voltage line RVL_odd, and the subpixels SP electrically connected to the second gate line GL2 may be electrically connected to the even-numbered reference voltage line RVL_even.

Since the magnitude of the data voltage Vdata supplied to the subpixels SP electrically connected to the odd-numbered reference voltage line RVL_odd is larger than the first reference voltage Vref1, the subpixels SP electrically connected to the odd-numbered reference voltage line RVL_odd may be in an emission state.

Since the magnitude of the data voltage Vdata supplied to the subpixels SP electrically connected to the even-numbered reference voltage line RVL_even is smaller than the second reference voltage Vref2, the subpixels SP electrically connected to the even-numbered reference voltage line RVL_even may be maintained in a non-emission state. In other words, storage capacitors Cst included in the subpixels SP electrically connected to the even-numbered reference voltage line RVL_even may be initialized.

For example, although the same data voltage Vdata is supplied to the 11th subpixel SP11 electrically connected to the first gate line GL1 and the 21st subpixel SP21 electrically connected to the second gate line GL2, the 11th subpixel SP11 may emit light, and the 21st subpixel SP21 may not emit light.

Referring to FIG. 6, in a period between the 112th time point t112 and a 113th time point t113, turn-on gate signals may be supplied to the third gate line GL3 and the fourth gate line GL4 at the 112th time point t112 as the same time point, and may be maintained.

In the period between the 112th time point t112 and the 113th time point t113, the data voltage Vdata may be supplied through the plurality of data lines DL to subpixels SP electrically connected to the third gate line GL3 and subpixels SP electrically connected to the fourth gate line GL4. For example, the same data voltage Vdata may be supplied to the 31st subpixel SP31 electrically connected to the third gate line GL3 and the 41st subpixel SP41 electrically connected to the fourth gate line GL4.

The period between the 112th time point t112 and the 113th time point t113 may be a period in which the first reference voltage Vref1 is supplied to an odd-numbered reference voltage line RVL_odd and the second reference voltage Vref2 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

Referring to FIG. 4, the subpixels SP electrically connected to the third gate line GL3 may be electrically connected to the odd-numbered reference voltage line RVL_odd, and the subpixels SP electrically connected to the fourth gate line GL4 may be electrically connected to the even-numbered reference voltage line RVL_even.

Since the magnitude of the data voltage Vdata supplied to the subpixels SP electrically connected to the odd-numbered reference voltage line RVL_odd is larger than the first reference voltage Vref1, the subpixels SP electrically connected to the odd-numbered reference voltage line RVL_odd may be in an emission state.

Since the magnitude of the data voltage Vdata supplied to the subpixels SP electrically connected to the even-numbered reference voltage line RVL_even is smaller than the second reference voltage Vref2, the subpixels SP electrically connected to the even-numbered reference voltage line RVL_even may be maintained in a non-emission state. In other words, storage capacitors Cst included in the subpixels SP electrically connected to the even-numbered reference voltage line RVL_even may be initialized.

For example, although the same data voltage Vdata is supplied to the 31st subpixel SP31 electrically connected to the third gate line GL3 and the 41st subpixel SP41 electrically connected to the fourth gate line GL4, the 31st subpixel SP31 may emit light, and the 41st subpixel SP41 may not emit light.

Referring to FIG. 6, in a period between a 11kth time point t11k and a 121st time point t121, turn-on gate signals may be supplied to the (n−1)th gate line GLn-1 and the nth gate line GLn at the 11kth time point t11k as the same time point, and may be maintained. n and k may be natural numbers of 1 or greater, and a relationship between k and n may be n=2k. However, the present disclosure is not limited thereto.

In the period between the 11kth time point t11k and the 121st time point t121, the data voltage Vdata may be supplied through the plurality of data lines DL to subpixels SP electrically connected to the (n−1)th gate line GLn-1 and subpixels SP electrically connected to the nth gate line GLn. For example, the same data voltage Vdata may be supplied to an (n−11)th subpixel SPn-11 electrically connected to the (n−1)th gate line GLn-1 and an n1th subpixel SPn1 electrically connected to the nth gate line GLn.

The period between the 11kth time point t11k and the 121st time point t121 may be a period in which the first reference voltage Vref1 is supplied to an odd-numbered reference voltage line RVL_odd and the second reference voltage Vref2 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

The subpixels SP electrically connected to the (n−1)th gate line GLn-1 may be electrically connected to the odd-numbered reference voltage line RVL_odd, and the subpixels SP electrically connected to the nth gate line GLn may be electrically connected to the even-numbered reference voltage line RVL_even.

Since the magnitude of the data voltage Vdata supplied to the subpixels SP electrically connected to the odd-numbered reference voltage line RVL_odd is larger than the first reference voltage Vref1, the subpixels SP electrically connected to the odd-numbered reference voltage line RVL_odd may be in an emission state.

Since the magnitude of the data voltage Vdata supplied to the subpixels SP electrically connected to the even-numbered reference voltage line RVL_even is smaller than the second reference voltage Vref2, the subpixels SP electrically connected to the even-numbered reference voltage line RVL_even may be maintained in a non-emission state. In other words, storage capacitors Cst included in the subpixels SP electrically connected to the even-numbered reference voltage line RVL_even may be initialized.

Namely, in the 11th sub frame period SF11, only some subpixels SP may be in an emission state, and remaining subpixels SP may be in a non-emission state. Since the remaining subpixels SP are in a non-emission state, storage capacitors Cst included in the remaining subpixels SP may be initialized. In other words, since the remaining subpixels SP may be subpixels SP which are electrically connected to an even-numbered reference voltage line RVL_even, the storage capacitors Cst included in the remaining subpixels SP may be initialized during the 11th sub frame period SF11.

For example, although the same data voltage Vdata is supplied to the (n−11)th subpixel SPn-11 electrically connected to the (n−1)th gate line GLn-1 and the n1th subpixel SPn1 electrically connected to the nth gate line GLn, the (n−11)th subpixel SPn-11 may emit light, and the n1th subpixel SPn1 may not emit light.

Referring to FIG. 6, in a period between the 121st time point t121 and a 122nd time point t122, turn-on gate signals may be supplied to the first gate line GL1 and the second gate line GL2 at the 121st time point t121 as the same time point, and may be maintained.

In the period between the 121st time point t121 and the 122nd time point t122, the data voltage Vdata may be supplied through the plurality of data lines DL to the subpixels SP electrically connected to the first gate line GL1 and the subpixels SP electrically connected to the second gate line GL2. For example, the same data voltage Vdata may be supplied to the 11th subpixel SP11 electrically connected to the first gate line GL1 and the 21st subpixel SP21 electrically connected to the second gate line GL2.

The period between the 121st time point t121 and the 122nd time point t122 may be a period in which the second reference voltage Vref2 is supplied to an odd-numbered reference voltage line RVL_odd and the first reference voltage Vref1 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

Referring to FIG. 4, the subpixels SP electrically connected to the first gate line GL1 may be electrically connected to the odd-numbered reference voltage line RVL_odd, and the subpixels SP electrically connected to the second gate line GL2 may be electrically connected to the even-numbered reference voltage line RVL_even.

Since the magnitude of the data voltage Vdata supplied to the subpixels SP electrically connected to the even-numbered reference voltage line RVL_even is larger than the first reference voltage Vref1, the subpixels SP electrically connected to the even-numbered reference voltage line RVL_even may be in an emission state.

Since the magnitude of the data voltage Vdata supplied to the subpixels SP electrically connected to the odd-numbered reference voltage line RVL_odd is smaller than the second reference voltage Vref2, the subpixels SP electrically connected to the odd-numbered reference voltage line RVL_odd may be maintained in a non-emission state. In other words, storage capacitors Cst included in the subpixels SP electrically connected to the odd-numbered reference voltage line RVL_odd may be initialized.

For example, although the same data voltage Vdata is supplied to the 11th subpixel SP11 electrically connected to the first gate line GL1 and the 21st subpixel SP21 electrically connected to the second gate line GL2, the 21st subpixel SP21 may emit light, and the 11th subpixel SP11 may not emit light.

Referring to FIG. 6, in a period between the 122nd time point t122 and a 123rd time point t123, turn-on gate signals may be supplied to the third gate line GL3 and the fourth gate line GL4 at the 122nd time point t122 as the same time point, and may be maintained.

In the period between the 122nd time point t122 and the 123rd time point t123, the data voltage Vdata may be supplied through the plurality of data lines DL to the subpixels SP electrically connected to the third gate line GL3 and the subpixels SP electrically connected to the fourth gate line GL4. For example, the same data voltage Vdata may be supplied to the 31st subpixel SP31 electrically connected to the third gate line GL3 and the 41st subpixel SP41 electrically connected to the fourth gate line GL4.

The period between the 122nd time point t122 and the 123rd time point t123 may be a period in which the second reference voltage Vref2 is supplied to an odd-numbered reference voltage line RVL_odd and the first reference voltage Vref1 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

Referring to FIG. 4, the subpixels SP electrically connected to the third gate line GL3 may be electrically connected to the odd-numbered reference voltage line RVL_odd, and the subpixels SP electrically connected to the fourth gate line GL4 may be electrically connected to the even-numbered reference voltage line RVL_even.

Since the magnitude of the data voltage Vdata supplied to the subpixels SP electrically connected to the even-numbered reference voltage line RVL_even is larger than the first reference voltage Vref1, the subpixels SP electrically connected to the even-numbered reference voltage line RVL_even may be in an emission state.

Since the magnitude of the data voltage Vdata supplied to the subpixels SP electrically connected to the odd-numbered reference voltage line RVL_odd is smaller than the second reference voltage Vref2, the subpixels SP electrically connected to the odd-numbered reference voltage line RVL_odd may be maintained in a non-emission state. In other words, storage capacitors Cst included in the subpixels SP electrically connected to the odd-numbered reference voltage line RVL_odd may be initialized.

For example, although the same data voltage Vdata is supplied to the 31st subpixel SP31 electrically connected to the third gate line GL3 and the 41st subpixel SP41 electrically connected to the fourth gate line GL4, the 41st subpixel SP41 may emit light, and the 31st subpixel SP31 may not emit light.

Referring to FIG. 6, in a period between a 12kth time point t12k and a 211th time point t211, turn-on gate signals may be supplied to the (n−1)th gate line GLn-1 and the nth gate line GLn at the 12kth time point t12k as the same time point, and may be maintained. n and k may be natural numbers of 1 or greater, and a relationship between k and n may be n=2k. However, the present disclosure is not limited thereto.

In the period between the 12kth time point t12k and the 211th time point t211, the data voltage Vdata may be supplied through the plurality of data lines DL to the subpixels SP electrically connected to the (n−1)th gate line GLn-1 and the subpixels SP electrically connected to the nth gate line GLn. For example, the same data voltage Vdata may be supplied to the (n−11)th subpixel SPn-11 electrically connected to the (n−1)th gate line GLn-1 and the n1th subpixel SPn1 electrically connected to the nth gate line GLn.

The period between the 12kth time point t12k and the 211th time point t211 may be a period in which the second reference voltage Vref2 is supplied to an odd-numbered reference voltage line RVL_odd and the first reference voltage Vref1 is supplied to an even-numbered reference voltage line RVL_even.

The magnitude of the second reference voltage Vref2 may be larger than the magnitude of the first reference voltage Vref1. The magnitude of the second reference voltage Vref2 may be larger than or the same as the magnitude of the data voltage Vdata supplied to the data line DL.

The subpixels SP electrically connected to the (n−1)th gate line GLn-1 may be electrically connected to the odd-numbered reference voltage line RVL_odd, and the subpixels SP electrically connected to the nth gate line GLn may be electrically connected to the even-numbered reference voltage line RVL_even.

Since the magnitude of the data voltage Vdata supplied to the subpixels SP electrically connected to the even-numbered reference voltage line RVL_even is larger than the first reference voltage Vref1, the subpixels SP electrically connected to the even-numbered reference voltage line RVL_even may be in an emission state.

Since the magnitude of the data voltage Vdata supplied to the subpixels SP electrically connected to the odd-numbered reference voltage line RVL_odd is smaller than the second reference voltage Vref2, the subpixels SP electrically connected to the odd-numbered reference voltage line RVL_odd may be maintained in a non-emission state. In other words, storage capacitors Cst included in the subpixels SP electrically connected to the odd-numbered reference voltage line RVL_odd may be initialized.

For example, although the same data voltage Vdata is supplied to the (n−11)th subpixel SPn-11 electrically connected to the (n−1)th gate line GLn-1 and the n1th subpixel SPn1 electrically connected to the nth gate line GLn, the (n−11)th subpixel SPn-11 may not emit light, and the n1th subpixel SPn1 may emit light.

Namely, in the 12th sub frame period SF12, only remaining subpixels SP may be in an emission state, and some subpixels SP may be in a non-emission state. Since the some subpixels SP are in a non-emission state, storage capacitors Cst included in the some subpixels SP may be initialized. In other words, since the some subpixels SP may be subpixels SP which are electrically connected to an odd-numbered reference voltage line RVL_odd, the storage capacitors Cst included in the some subpixels SP may be initialized during the 12th sub frame period SF12.

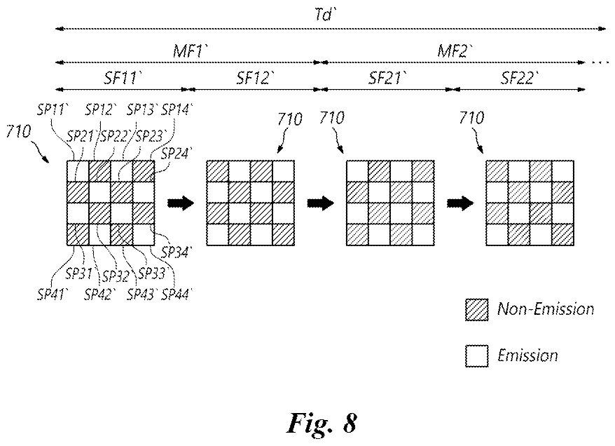

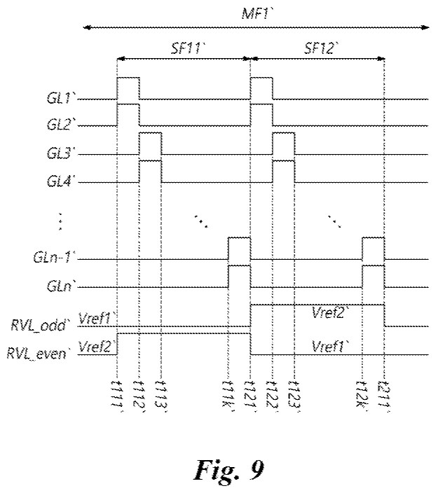

FIG. 7 is a diagram illustrating the circuit structure of subpixels SP disposed in a display panel 710 in accordance with a second embodiment of the present disclosure. FIG. 8 is a diagram illustrating driving of the display panel 710 in accordance with the second embodiment of the present disclosure. FIG. 9 is a diagram illustrating driving timing of a display device 100 in accordance with the second embodiment of the present disclosure.

In a display panel 710, a plurality of data lines DL, a plurality of reference voltage lines RVL, a plurality of gate lines GL and a plurality of subpixels SP may be disposed.

Referring to FIG. 7, the plurality of subpixels SP may include an 11th subpixel SP11′ to a 22nd subpixel SP22. Each of the plurality of subpixels SP may include elements such as a driving transistor DRT, a scan transistor SCT, a sensing transistor SENT, a light emitting element ED and a storage capacitor Cst, which is the same as the characteristics of the subpixel SP illustrated in FIG. 2.

Referring to FIG. 7, the plurality of data lines DL may include a first data line DL1′ and a second data line DL2′.

Referring to FIG. 7, the plurality of reference voltage lines RVL may include a first reference voltage line RVL1′ and a second reference voltage line RVL2′. The plurality of reference voltage lines RVL may be classified into an odd-numbered reference voltage line RVL2b-1 (b is a natural number) (hereinafter denoted as “RVL_odd′ ”) and an even-numbered reference voltage line RVL2b (b is a natural number) (hereinafter denoted as “RVL_even′ ”) on the basis of an order in which the plurality of reference voltage lines RVL are disposed. The first reference voltage line RVL1′ may be included in the odd-numbered reference voltage line RVL_odd′, and the second reference voltage line RVL2′ may be included in the even-numbered reference voltage line RVL_even′.

The first data line DL1′ may be electrically connected to the 11th subpixel SP11′ and the 21st subpixel SP21′. The first data line DL1′ may be electrically connected to the scan transistor SCT of each of the 11th subpixel SP11′ and the 21st subpixel SP21′.

The second data line DL2′ may be electrically connected to the 12th subpixel SP12′ and the 22nd subpixel SP22′. The second data line DL2′ may be electrically connected to the scan transistor SCT of each of the 12th subpixel SP12′ and the 22nd subpixel SP22′.

The first reference voltage line RVL1′ may be electrically connected to the 11th subpixel SP11′ and the 22nd subpixel SP22′. The first reference voltage line RVL1′ may be electrically connected to the sensing transistor SENT of each of the 11th subpixel SP11′ and the 22nd subpixel SP22′.

The second reference voltage line RVL2′ may be electrically connected to the 12th subpixel SP12′ and the 21st subpixel SP21′. The second reference voltage line RVL2′ may be electrically connected to the sensing transistor SENT of each of the 12th subpixel SP12′ and the 21st subpixel SP21′.

A first reference voltage Vref1′ or a second reference voltage Vref2′ may be supplied to the first reference voltage line RVL1′. The first reference voltage Vref1′ or the second reference voltage Vref2′ may be supplied to the second reference voltage line RVL2′.

When the first reference voltage Vref1′ is supplied to the first reference voltage line RVL1′, the second reference voltage Vref2′ may be supplied to the second reference voltage line

RVL2′. When the second reference voltage Vref2′ is supplied to the first reference voltage line RVL1′, the first reference voltage Vref1′ may be supplied to the second reference voltage line RVL2′.

The magnitude of the second reference voltage Vref2′ may be larger than the magnitude of the first reference voltage Vref1′.

The magnitude of the second reference voltage Vref2′ may be larger than the magnitude of a data voltage Vdata supplied to the data line DL. Alternatively, the magnitude of the second reference voltage Vref2′ may be the same as the magnitude of the data voltage Vdata supplied to the data line DL.

A first scan signal SCAN1 may be supplied to the 11th subpixel SP11′ and the 12th subpixel SP12′ through a first gate line GL1, and may be supplied to the gate nodes of the scan transistors SCT and the sensing transistors SENT. A second scan signal SCAN2 may be supplied to the 21st subpixel SP21′ and the 22nd subpixel SP22′ through a second gate line GL2, and may be supplied to the gate nodes of the scan transistors SCT and the sensing transistors SENT.

That is to say, the plurality of subpixels SP may be driven in a “one-scan” structure. However, the present disclosure is not limited thereto, and as a sense signal SENSE is supplied to the sensing transistor SENT, the scan transistor SCT and the sensing transistor SENT may be individually controlled.

For each two columns in which subpixels SP are disposed, an odd-numbered reference voltage line RVL_odd and an even-numbered reference voltage line RVL_even as two reference voltage lines may be disposed. When considering, as one unit, four subpixels SP adjacent to one another in longitudinal and transverse directions, two subpixels SP adjacent to each other in a diagonal direction (extending between a left upper end to a right lower end) may be electrically connected to an odd-numbered reference voltage line RVL_odd, and remaining two subpixels SP adjacent to each other in a diagonal direction (extending between a right upper end to a left lower end) may be electrically connected to an even-numbered reference voltage line RVL_even.

For each one column in which subpixels SP are disposed, an odd-numbered reference voltage line RVL_odd and an even-numbered reference voltage line RVL_even as two reference voltage lines may be disposed. In a first column, when considering, as one unit, two subpixels SP adjacent to each other in a longitudinal direction, one subpixel SP may be electrically connected to an odd-numbered reference voltage line RVL_odd, and the remaining one subpixel SP may be electrically connected to an even-numbered reference voltage line RVL_even. In a second column, when considering, as one unit, two subpixels SP adjacent to each other in a longitudinal direction, one subpixel SP may be electrically connected to an even-numbered reference voltage line RVL_even, and the remaining one subpixel SP may be electrically connected to an odd-numbered reference voltage line RVL_odd.

Driving of the display panel 710 including the subpixels SP will be described below.

Referring to FIG. 8, a driving period Td′ of the display device 100 may include a plurality of main frame periods MF′ for displaying an image on the display panel 710.

The plurality of main frame periods MF′ may include a first main frame period MF1′ and a second main frame period MF2′.

Referring to FIG. 8, the first main frame period MF1′ during which the plurality of subpixels SP emit light may include an 11th sub frame period SF11′ and a 12th sub frame period SF12′.

Referring to FIG. 8, whether the display panel 710 emits light may be checked, and for the sake of convenience in explanation, it is illustrated that only an 11th subpixel SP11′ to a 44th subpixel SP44′ are disposed in the display panel 710. The number of subpixels SP disposed in the display panel 710 is not limited.

The 11th sub frame period SF11′ may be a period in which some subpixels SP among the plurality of subpixels SP emit light. Some subpixels SP may be the 11th subpixel SP11′, the 22nd subpixel SP22′, the 13th subpixel SP13′, the 24th subpixel SP24′, the 31st subpixel SP31′, the 42nd subpixel SP42′, the 33rd subpixel SP33′ and the 44th subpixel SP44′ which are subpixels SP connected to an odd-numbered reference voltage line RVL_odd′. That is to say, some subpixels SP may be subpixels SP which are electrically connected to an odd-numbered reference voltage line RVL_odd′.

The 12th sub frame period SF12′ may be a period in which remaining subpixels SP except the some subpixels SP among the plurality of subpixels SP are in an emission state. Remaining subpixels SP may be the 21st subpixel SP21′, the 12th subpixel SP12′, the 23rd subpixel SP23′, the 14th subpixel SP14′, the 41st subpixel SP41′, the 32nd subpixel SP32′, the 43rd subpixel SP43′ and the 34th subpixel S34′ which are subpixels SP connected to an even-numbered reference voltage line RVL_even′. That is to say, remaining subpixels SP may be subpixels SP which are electrically connected to an even-numbered reference voltage line RVL_even′.

In the 11th sub frame period SF11′, only the some subpixels SP may be in an emission state, and the remaining subpixels SP may be in a non-emission state. Since the remaining subpixels SP are in a non-emission state, storage capacitors Cst included in the remaining subpixels SP may be initialized. In other words, since the remaining subpixels SP may be subpixels SP which are electrically connected to an even-numbered reference voltage line RVL_even′, the storage capacitors Cst included in the remaining subpixels SP may be initialized during the 11th sub frame period SF11′.

In the 12th sub frame period SF12′, only the remaining subpixels SP may be in an emission state, and the some subpixels SP may be in a non-emission state. Since the some subpixels SP are in a non-emission state, storage capacitors Cst included in the some subpixels SP may be initialized. In other words, since the some subpixels SP may be subpixels SP which are electrically connected to an odd-numbered reference voltage line RVL_odd′, the storage capacitors Cst included in the some subpixels SP may be initialized during the 12th sub frame period SF12′.

Namely, during the first main frame period MF1′ for displaying one frame image, storage capacitors Cst included in all subpixels SP undergo an initialization process, and thus, a moving picture response time (MPRT) may be improved.

After the first main frame period MF1′, the second main frame period MF2′ may proceed. The second main frame period MF2′ may include a 21st sub frame period SF21′ and a 22nd sub frame period SF22′. The characteristics of the 21st sub frame period SF21′ may be the same as those of the 11th sub frame period SF11′, and the characteristics of the 22nd sub frame period SF22′ may be the same as those of the 12th sub frame period SF12′.

After the second main frame period MF2′, a plurality of main frame periods MF may repeatedly proceed.

Following the above description of driving of the display panel 710, a method for driving the display device 100 will be described below in detail with reference to a timing diagram of signals.

Referring to FIG. 9, signals supplied to a first gate line GL1′ to an nth gate line GLn′ included in the display device 100 and time points at which the signals are supplied may be checked.

The display device 100 may include the plurality of reference voltage lines RVL, and the plurality of reference voltage lines RVL may be classified into an odd-numbered reference voltage line RVL_odd′ and an even-numbered reference voltage line RVL_even′ on the basis of an order in which the plurality of reference voltage lines RVL are disposed.

The first reference voltage Vref1′ or the second reference voltage Vref2′ may be supplied to the odd-numbered reference voltage line RVL_odd′. The first reference voltage Vref1′ or the second reference voltage Vref2′ may be supplied to the even-numbered reference voltage line RVL_even′. The magnitude of the second reference voltage Vref2′ may be larger than the magnitude of the first reference voltage Vref1′. The second reference voltage Vref2′ may be the second-first reference voltage Vref2-1′ or the second-second reference voltage Vref2-2′.

Referring to FIG. 9, the first main frame period MF1′ during which the plurality of subpixels SP emit light may include the 11th sub frame period SF11′ and the 12th sub frame period SF12′.

The 11th sub frame period SF11′ may be a period in which the first reference voltage Vref1′ is supplied to the odd-numbered reference voltage line RVL_odd′ and the second reference voltage Vref2′ is supplied to the even-numbered reference voltage line RVL_even′.

The 12th sub frame period SF12′ may be a period in which the second reference voltage Vref2′ is supplied to the odd-numbered reference voltage line RVL_odd′ and the first reference voltage Vref1′ is supplied to the even-numbered reference voltage line RVL_even′.

The odd-numbered reference voltage line RVL_odd′ may be connected to a subpixel SP which is disposed in an odd-numbered row and an odd-numbered column, and may be connected to a subpixel SP which is disposed in an even-numbered row and an even-numbered column. Referring to FIG. 7, the 11th subpixel SP11′ and the 22nd subpixel SP22′ may be electrically connected to the first reference voltage line RVL1′ which is an odd-numbered reference voltage line RVL_odd′.

The even-numbered reference voltage line RVL_even′ may be connected to a subpixel SP which is disposed in an odd-numbered row and an even-numbered column, and may be connected to a subpixel SP which is disposed in an even-numbered row and an odd-numbered column. Referring to FIG. 7, the 12th subpixel SP12′ and the 21st subpixel SP21′ may be electrically connected to the second reference voltage line RVL2′ which is an even-numbered reference voltage line RVL_even′.

The emission state of a subpixel SP may vary depending on whether or not the light emitting element ED included in the subpixel SP emits light or a luminance of light emission. Whether or not the light emitting element ED included in the subpixel SP emits light or a luminance of light emission may vary depending on the data voltage Vdata supplied to the first node N1 and the reference voltage Vref supplied to the second node N2. When the data voltage Vdata is higher than the reference voltage Vref, an image may be displayed. When the data voltage Vdata is lower than the reference voltage Vref, the driving transistor DRT does not flow the driving current Ids, and thus, the light emitting element ED may be maintained in a non-emission state.

Referring to FIG. 9, in a period between a 111th time point t111′ and a 112th time point t112′, turn-on gate signals may be supplied to the first gate line GL1′ and the second gate line GL2′ at the 111th time point t111′ as the same time point, and may be maintained.

In the period between the 111th time point t111′ and the 112th time point t112′, the data voltage Vdata may be supplied through the plurality of data lines DL to subpixels SP electrically connected to the first gate line GL1′ and subpixels SP electrically connected to the second gate line GL2′. For example, the same data voltage Vdata may be supplied to the 11th subpixel SP11′ electrically connected to the first gate line GL1′ and the 21st subpixel SP21′ electrically connected to the second gate line GL2′.

The period between the 111th time point t111′ and the 112th time point t112′ may be a period in which the first reference voltage Vref1′ is supplied to an odd-numbered reference voltage line RVL_odd′ and the second reference voltage Vref2′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the odd-numbered reference voltage line RVL_odd′ is larger than the first reference voltage Vref1′, the subpixels SP electrically connected to the odd-numbered reference voltage line RVL_odd′ may be in an emission state.

Since the magnitude of the data voltage Vdata supplied to the subpixels SP electrically connected to the even-numbered reference voltage line RVL_even′ is smaller than the second reference voltage Vref2′, the subpixels SP electrically connected to the even-numbered reference voltage line RVL_even′ may be maintained in a non-emission state. In other words, storage capacitors Cst included in the subpixels SP electrically connected to the even-numbered reference voltage line RVL_even′ may be initialized.

For example, although the same data voltage Vdata is supplied to the 11th subpixel SP11′ electrically connected to the first gate line GL1′ and the 21st subpixel SP21′ electrically connected to the second gate line GL2′, the 11th subpixel SP11′ may emit light, and the 21st subpixel SP21′ may not emit light.

Referring to FIG. 9, in a period between the 112th time point t112′ and a 113th time point t113′, turn-on gate signals may be supplied to the third gate line GL3′ and the fourth gate line GL4′ at the 112th time point t112′ as the same time point, and may be maintained.

In the period between the 112th time point t112′ and the 113th time point t113′, the data voltage Vdata may be supplied through the plurality of data lines DL to subpixels SP electrically connected to the third gate line GL3′ and subpixels SP electrically connected to the fourth gate line GL4′. For example, the same data voltage Vdata may be supplied to the 31st subpixel SP31′ electrically connected to the third gate line GL3′ and the 41st subpixel SP41′ electrically connected to the fourth gate line GL4′.

The period between the 112th time point t112′ and the 113th time point t113′ may be a period in which the first reference voltage Vref1′ is supplied to an odd-numbered reference voltage line RVL_odd′ and the second reference voltage Vref2′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the odd-numbered reference voltage line RVL_odd′ is larger than the first reference voltage Vref1′, the subpixels SP electrically connected to the odd-numbered reference voltage line RVL_odd′ may be in an emission state.

Since the magnitude of the data voltage Vdata supplied to the subpixels SP electrically connected to the even-numbered reference voltage line RVL_even′ is smaller than the second reference voltage Vref2′, the subpixels SP electrically connected to the even-numbered reference voltage line RVL_even′ may be maintained in a non-emission state. In other words, storage capacitors Cst included in the subpixels SP electrically connected to the even-numbered reference voltage line RVL_even′ may be initialized.

For example, although the same data voltage Vdata is supplied to the 31st subpixel SP31′ electrically connected to the third gate line GL3′ and the 41st subpixel SP41′ electrically connected to the fourth gate line GL4′, the 31st subpixel SP31′ may emit light, and the 41st subpixel SP41′ may not emit light.

Referring to FIG. 9, in a period between a 11kth time point t11k′ and a 121st time point t121′, turn-on gate signals may be supplied to the (n−1)th gate line GLn-1′ and the nth gate line GLn′ at the 11kth time point t11k′ as the same time point, and may be maintained. n and k may be natural numbers of 1 or greater, and a relationship between k and n may be n=2k. However, the present disclosure is not limited thereto.

In the period between the 11kth time point t11k′ and the 121st time point t121′, the data voltage Vdata may be supplied through the plurality of data lines DL to subpixels SP electrically connected to the (n−1)th gate line GLn-1′ and subpixels SP electrically connected to the nth gate line GLn′. For example, the same data voltage Vdata may be supplied to the (n−11)th subpixel SPn-11′ electrically connected to the (n−1)th gate line GLn-1′ and the n1th subpixel SPn1′ electrically connected to the nth gate line GLn′.

The period between the 11kth time point t11k′ and the 121st time point t121′ may be a period in which the first reference voltage Vref1′ is supplied to an odd-numbered reference voltage line RVL_odd′ and the second reference voltage Vref2′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the odd-numbered reference voltage line RVL_odd′ is larger than the first reference voltage Vref1′, the subpixels SP electrically connected to the odd-numbered reference voltage line RVL_odd′ may be in an emission state.

Since the magnitude of the data voltage Vdata supplied to the subpixels SP electrically connected to the even-numbered reference voltage line RVL_even′ is smaller than the second reference voltage Vref2′, the subpixels SP electrically connected to the even-numbered reference voltage line RVL_even′ may be maintained in a non-emission state. In other words, storage capacitors Cst included in the subpixels SP electrically connected to the even-numbered reference voltage line RVL_even′ may be initialized.

Namely, in the 11th sub frame period SF11′, only some subpixels SP may be in an emission state, and remaining subpixels SP may be in a non-emission state. Since the remaining subpixels SP are in a non-emission state, storage capacitors Cst included in the remaining subpixels SP may be initialized. In other words, since the remaining subpixels SP may be subpixels SP which are electrically connected to an even-numbered reference voltage line RVL_even′, the storage capacitors Cst included in the remaining subpixels SP may be initialized during the 11th sub frame period SF11′.

For example, although the same data voltage Vdata is supplied to the (n−11)th subpixel SPn-11′ electrically connected to the (n−1)th gate line GLn-1′ and the n1th subpixel SPn1′ electrically connected to the nth gate line GLn′, the (n−11)th subpixel SPn-11′ may emit light, and the n1th subpixel SPn1′ may not emit light.

Referring to FIG. 9, in a period between the 121st time point t121′ and a 122nd time point t122′, turn-on gate signals may be supplied to the first gate line GL1′ and the second gate line GL2′ at the 121st time point t121′ as the same time point, and may be maintained.

In the period between the 121st time point t121′ and the 122nd time point t122′, the data voltage Vdata may be supplied through the plurality of data lines DL to the subpixels SP electrically connected to the first gate line GL1′ and the subpixels SP electrically connected to the second gate line GL2′. For example, the same data voltage Vdata may be supplied to the 11th subpixel SP11′ electrically connected to the first gate line GL1′ and the 21st subpixel SP21′ electrically connected to the second gate line GL2′.

The period between the 121st time point t121′ and the 122nd time point t122′ may be a period in which the second reference voltage Vref2′ is supplied to an odd-numbered reference voltage line RVL_odd′ and the first reference voltage Vref1′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the even-numbered reference voltage line RVL_even′ is larger than the first reference voltage Vref1′, the subpixels SP electrically connected to the even-numbered reference voltage line RVL_even′ may be in an emission state.

Since the magnitude of the data voltage Vdata supplied to the subpixels SP electrically connected to the odd-numbered reference voltage line RVL_odd′ is smaller than the second reference voltage Vref2′, the subpixels SP electrically connected to the odd-numbered reference voltage line RVL_odd′ may be maintained in a non-emission state. In other words, storage capacitors Cst included in the subpixels SP electrically connected to the odd-numbered reference voltage line RVL_odd′ may be initialized.

For example, although the same data voltage Vdata is supplied to the 11th subpixel SP11′ electrically connected to the first gate line GL1′ and the 21st subpixel SP21′ electrically connected to the second gate line GL2′, the 21st subpixel SP21′ may emit light, and the 11th subpixel SP11′ may not emit light.

Referring to FIG. 9, in a period between the 122nd time point t122′ and a 123rd time point t123′, turn-on gate signals may be supplied to the third gate line GL3′ and the fourth gate line GL4′ at the 122nd time point t122′ as the same time point, and may be maintained.

In the period between the 122nd time point t122′ and the 123rd time point t123′, the data voltage Vdata may be supplied through the plurality of data lines DL to the subpixels SP electrically connected to the third gate line GL3′ and the subpixels SP electrically connected to the fourth gate line GL4′. For example, the same data voltage Vdata may be supplied to the 31st subpixel SP31′ electrically connected to the third gate line GL3′ and the 41st subpixel SP41′ electrically connected to the fourth gate line GL4′.

The period between the 122nd time point t122′ and the 123rd time point t123′ may be a period in which the second reference voltage Vref2′ is supplied to an odd-numbered reference voltage line RVL_odd′ and the first reference voltage Vref1′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the even-numbered reference voltage line RVL_even′ is larger than the first reference voltage Vref1′, the subpixels SP electrically connected to the even-numbered reference voltage line RVL_even′ may be in an emission state.

Since the magnitude of the data voltage Vdata supplied to the subpixels SP electrically connected to the odd-numbered reference voltage line RVL_odd′ is smaller than the second reference voltage Vref2′, the subpixels SP electrically connected to the odd-numbered reference voltage line RVL_odd′ may be maintained in a non-emission state. In other words, storage capacitors Cst included in the subpixels SP electrically connected to the odd-numbered reference voltage line RVL_odd′ may be initialized.

For example, although the same data voltage Vdata is supplied to the 31st subpixel SP31′ electrically connected to the third gate line GL3′ and the 41st subpixel SP41′ electrically connected to the fourth gate line GL4′, the 41st subpixel SP41′ may emit light, and the 31st subpixel SP31′ may not emit light.

Referring to FIG. 9, in a period between a 12kth time point t12k′ and a 211th time point t211′, turn-on gate signals may be supplied to the (n−1)th gate line GLn-1′ and the nth gate line

GLn′ at the 12kth time point t12k′ as the same time point, and may be maintained. n and k may be natural numbers of 1 or greater, and a relationship between k and n may be n=2k. However, the present disclosure is not limited thereto.

In the period between the 12kth time point t12k′ and the 211th time point t211′, the data voltage Vdata may be supplied through the plurality of data lines DL to the subpixels SP electrically connected to the (n−1)th gate line GLn-1′ and the subpixels SP electrically connected to the nth gate line GLn′. For example, the same data voltage Vdata may be supplied to the (n−11)th subpixel SPn-11′ electrically connected to the (n−1)th gate line GLn-1′ and the n1th subpixel SPn1′ electrically connected to the nth gate line GLn′.

The period between the 12kth time point t12k′ and the 211th time point t211′ may be a period in which the second reference voltage Vref2′ is supplied to an odd-numbered reference voltage line RVL_odd′ and the first reference voltage Vref1′ is supplied to an even-numbered reference voltage line RVL_even′.

The magnitude of the second reference voltage Vref2′ may be larger than the magnitude of the first reference voltage Vref1′. The magnitude of the second reference voltage Vref2′ may be larger than or the same as the magnitude of the data voltage Vdata supplied to the data line DL.

Since the magnitude of the data voltage Vdata supplied to the subpixels SP electrically connected to the even-numbered reference voltage line RVL_even′ is larger than the first reference voltage Vref1′, the subpixels SP electrically connected to the even-numbered reference voltage line RVL_even′ may be in an emission state.

Since the magnitude of the data voltage Vdata supplied to the subpixels SP electrically connected to the odd-numbered reference voltage line RVL_odd′ is smaller than the second reference voltage Vref2′, the subpixels SP electrically connected to the odd-numbered reference voltage line RVL_odd′ may be maintained in a non-emission state. In other words, storage capacitors Cst included in the subpixels SP electrically connected to the odd-numbered reference voltage line RVL_odd′ may be initialized.

For example, although the same data voltage Vdata is supplied to the (n−11)th subpixel SPn-11′ electrically connected to the (n−1)th gate line GLn-1′ and the n1th subpixel SPn1′ electrically connected to the nth gate line GLn′, the (n−11)th subpixel SPn-11′ may not emit light, and the n1th subpixel SPn1′ may emit light.

Namely, in the 12th sub frame period SF12′, only remaining subpixels SP may be in an emission state, and some subpixels SP may be in a non-emission state. Since the some subpixels SP are in a non-emission state, storage capacitors Cst included in the some subpixels SP may be initialized. In other words, since the some subpixels SP may be subpixels SP which are electrically connected to an odd-numbered reference voltage line RVL_odd′, the storage capacitors Cst included in the some subpixels SP may be initialized during the 12th sub frame period SF12′.

Namely, during the first main frame period MF1′ for displaying one frame image, storage capacitors Cst included in all subpixels SP undergo an initialization process, and thus, a moving picture response time (MPRT) may be improved.

Embodiments of the present disclosure may provide a display device 100 and a driving method thereof, capable of efficiently improving a moving picture response time (MPRT).

Embodiments of the present disclosure may provide a display device 100 and a driving method thereof, capable of low-power driving by efficiently improving a moving picture response time (MPRT).

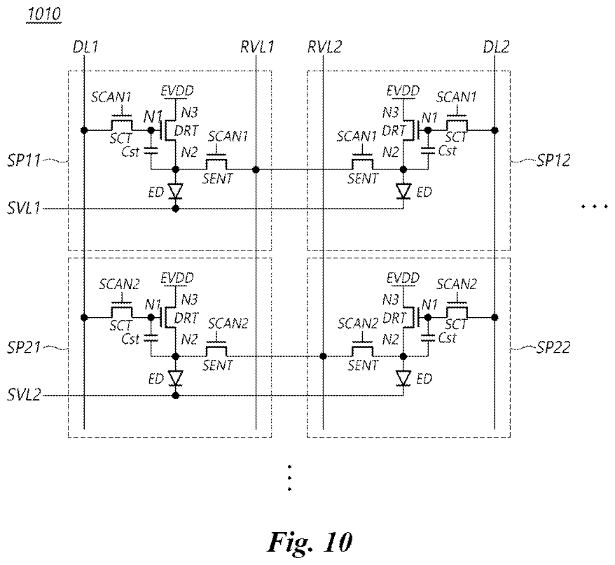

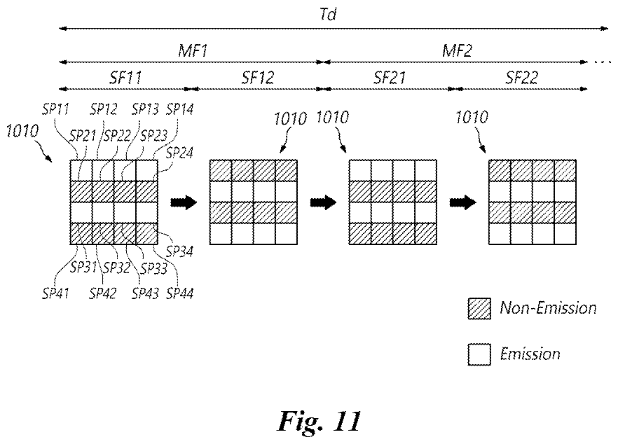

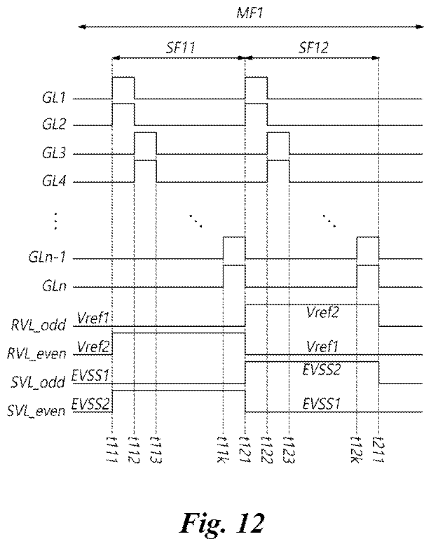

FIG. 10 is a diagram illustrating the circuit structure of subpixels SP disposed in a display panel 1010 in accordance with a third embodiment of the present disclosure. FIG. 11 is a diagram illustrating driving of the display panel 1010 in accordance with the third embodiment of the present disclosure. FIG. 12 is a diagram illustrating driving timing of a display device 100 in accordance with the third embodiment of the present disclosure.

Referring to FIG. 10, in a display panel 1010, a plurality of data lines DL, a plurality of reference voltage lines RVL, a plurality of gate lines GL and a plurality of subpixels SP may be disposed.

Referring to FIG. 10, although the plurality of subpixels SP are disposed in the display panel 1010, for the sake of convenience in explanation, the characteristics of the plurality of subpixels SP will be described by taking an 11th subpixel SP11 to a 22nd subpixel SP22 as an example.

The characteristics of scan transistors SCT, driving transistors DRT, sensing transistors SENT, light emitting elements ED and storage capacitors Cst included in the plurality of subpixels SP illustrated in FIG. 10 are the same as those of the plurality of subpixels SP illustrated in FIG. 4.

The electrical connection relationship between the plurality of data lines DL and the plurality of subpixels SP illustrated in FIG. 10 is the same as the electrical connection relationship between the plurality of data lines DL and the plurality of subpixels SP illustrated in FIG. 4.

The electrical connection relationship between a first reference voltage line RVL1 and the plurality of subpixels SP illustrated in FIG. 10 is the same as the electrical connection relationship between the first reference voltage line RVL1 and the plurality of subpixels SP illustrated in FIG. 4.

The electrical connection relationship between a second reference voltage line RVL2 and the plurality of subpixels SP illustrated in FIG. 10 is the same as the electrical connection relationship between the second reference voltage line RVL2 and the plurality of subpixels SP illustrated in FIG. 4.

The plurality of subpixels SP may be driven in a “one-scan” structure.

Referring to FIG. 10, a plurality of base voltage lines SVL may include a first base voltage line SVL1 and a second base voltage line SVL2. The plurality of base voltage lines SVL may be classified into an odd-numbered base voltage line SVL2a-1 (a is a natural number) (hereinafter denoted as “SVL_odd”) and an even-numbered base voltage line SVL2a (a is a natural number) (hereinafter denoted as “SVL_even”) on the basis of an order in which the plurality of base voltage lines SVL are disposed. The first base voltage line SVL1 may be included in the odd-numbered base voltage line SVL_odd, and the second base voltage line SVL2 may be included in the even-numbered base voltage line SVL_even.

The odd-numbered base voltage line SVL2a-1 may be electrically connected to subpixels SP which are disposed in the same odd-numbered row. The even-numbered base voltage line SVL2a may be electrically connected to subpixels SP which are disposed in the same even-numbered row. For example, referring to FIG. 10, the first base voltage line SVL1 may be electrically connected to the subpixels SP11 and SP12 which are disposed in a first row. The second base voltage line SVL2 may be electrically connected to the subpixels SP21 and SP22 which are disposed in a second row.

A first base voltage EVSS1 or a second base voltage EVSS2 may be supplied to the first base voltage line SVL1. The first base voltage EVSS1 or the second base voltage EVSS2 may be supplied to the second base voltage line SVL2.

When the first base voltage EVSS1 is supplied to the first base voltage line SVL1, the second base voltage EVSS2 may be supplied to the second base voltage line SVL2. When the second base voltage EVSS2 is supplied to the first base voltage line SVL1, the first base voltage EVSS1 may be supplied to the second base voltage line SVL2.

The magnitude of the second base voltage EVSS2 may be larger than the magnitude of the first base voltage EVSS1.

The plurality of subpixels SP may emit light by a BDI driving method. That is to say, the display panel 1010 may display a frame image through light emission of some subpixels SP, and remaining subpixels SP may be driven to display a black grayscale. In order to display a black grayscale, the remaining subpixels SP may be supplied with a predetermined voltage during the voltage supply step S1710. The remaining subpixels SP may be supplied with the data voltage Vdata through the data line DL, and may be supplied with the second reference voltage Vref2 through the reference voltage line RVL. The second reference voltage Vref2 may be higher than or the same as the data voltage Vdata. In other words, the storage capacitors Cst of the remaining subpixels SP are not charged with voltages for light emission.

The second base voltage EVSS2 may be higher than the threshold voltage Vth_ED of the light emitting element ED. In this case, the light emitting element ED may be in a state capable of emitting light. However, since the storage capacitor Cst is not charged with a voltage for light emission, the driving current Ids does not flow through the light emitting element ED. Accordingly, the light emitting element ED may emit light with a low grayscale. In order to prevent such a phenomenon, the remaining subpixels SP may be supplied with the second base voltage EVSS2. The second base voltage EVSS2 may be the same voltage as the second reference voltage Vref2, or the second base voltage EVSS2 may have a voltage magnitude obtained by subtracting the threshold voltage Vth_ED of the light emitting element ED from the second reference voltage Vref2. As the second base voltage EVSS2 is supplied to the cathode electrode of the light emitting element ED, the light emitting element ED may be maintained in a turn-off state. As the light emitting element ED is maintained in a turn-off state, current may not be supplied and thus the light emitting element ED may not emit light. Namely, by stably controlling the light emitting element ED, a moving picture response time (MPRT) may be efficiently improved.

Summarizing the foregoing, a feature that the subpixel SP is supplied with the second base voltage EVSS2 and thus the light emitting element ED does not emit light has been described. Next, a feature that, when BDI driving is performed, the display panel 1010 in which the plurality of subpixels SP are disposed emits light will be described below.

Referring to FIG. 11, a driving period Td of the display device 100 may include a plurality of main frame periods MF for displaying an image on the display panel 1010. The characteristics of the plurality of main frame periods MF and the light emission characteristics of the plurality of subpixels SP illustrated in FIG. 11 are the same as those illustrated in FIG. 5.

The light emission characteristics of the display panel 1010 illustrated in FIG. 11 are the same as the light emission characteristics of the display panel 410 illustrated in FIG. 5.

However, the plurality of subpixels SP illustrated in FIG. 11 are different from the plurality of subpixels SP illustrated in FIG. 5 in that the base voltage EVSS may be controlled to the first base voltage EVSS1 or the second base voltage EVSS2.

Referring to FIG. 12, signals supplied to a first gate line GL1 to an nth gate line GLn included in the display device 100 and time points t111, . . . , t211 at which the signals are supplied may be checked. The display device 100 may include the plurality of reference voltage lines RVL, and the plurality of reference voltage lines RVL may be classified into an odd-numbered reference voltage line RVL_odd and an even-numbered reference voltage line RVL_even on the basis of an order in which the plurality of reference voltage lines RVL are disposed.

A first reference voltage Vref1 or a second reference voltage Vref2 may be supplied to the odd-numbered reference voltage line RVL_odd. The first reference voltage Vref1 or the second reference voltage Vref2 may be supplied to the even-numbered reference voltage line RVL_even. The magnitude of the second reference voltage Vref2 may be larger than the magnitude of the first reference voltage Vref1.

Referring to FIG. 12, a first main frame period MF1 during which the plurality of subpixels SP emit light may include an 11th sub frame period SF11 and a 12th sub frame period SF12.

In the 11th sub frame period SF11 and 12th sub frame period SF12 shown in FIG. 12, the characteristics of the first gate line GL1 to the nth gate line GLn, the odd-numbered reference voltage line RVL_odd and the even-numbered reference voltage line RVL_even are the same as those shown in FIG. 6. However, there is a difference in that the voltage of the base voltage line SVL shown in FIG. 12 is controlled.

Referring to FIG. 12, the plurality of base voltage lines SVL may be classified into an odd-numbered base voltage line SVL_odd and an even-numbered base voltage line SVL_even on the basis of an order in which the plurality of base voltage lines SVL are disposed.

The first base voltage EVSS1 or the second base voltage EVSS2 may be supplied to the odd-numbered base voltage line SVL_odd. The first base voltage EVSS1 or the second base voltage EVSS2 may be supplied to the even-numbered base voltage line SVL_even. The magnitude of the second base voltage EVSS2 may be larger than the magnitude of the first base voltage EVSS1.

Referring to FIG. 12, the 11th sub frame period SF11 may be a period in which the first base voltage EVSS1 is supplied to the odd-numbered base voltage line SVL_odd and the second base voltage EVSS2 is supplied to the even-numbered base voltage line SVL_even.

Referring to FIG. 12, the 12th sub frame period SF12 may be a period in which the second base voltage EVSS2 is supplied to the odd-numbered base voltage line SVL_odd and the first base voltage EVSS1 is supplied to the even-numbered base voltage line SVL_even.

In the 11th sub frame period SF11, sub pixels SP supplied with the first base voltage EVSS1 may emit light to display a frame image. In the 11th sub frame period SF11, subpixels SP supplied with the second base voltage EVSS2 may display a black grayscale. Accordingly, the display panel 1010 may emit light like the display panel 1010 during the 11th sub frame period SF11 of FIG. 11.

In the 12th sub frame period SF12, sub pixels SP supplied with the second base voltage EVSS2 may emit light to display a frame image. In the 12th sub frame period SF12, subpixels SP supplied with the first base voltage EVSS1 may display a black grayscale. Accordingly, the display panel 1010 may emit light like the display panel 1010 during the 12th sub frame period SF12 of FIG. 11.

Namely, according to the third embodiment of the present disclosure, while stably controlling the light emitting element ED, a moving picture response time (MPRT) may be efficiently improved.

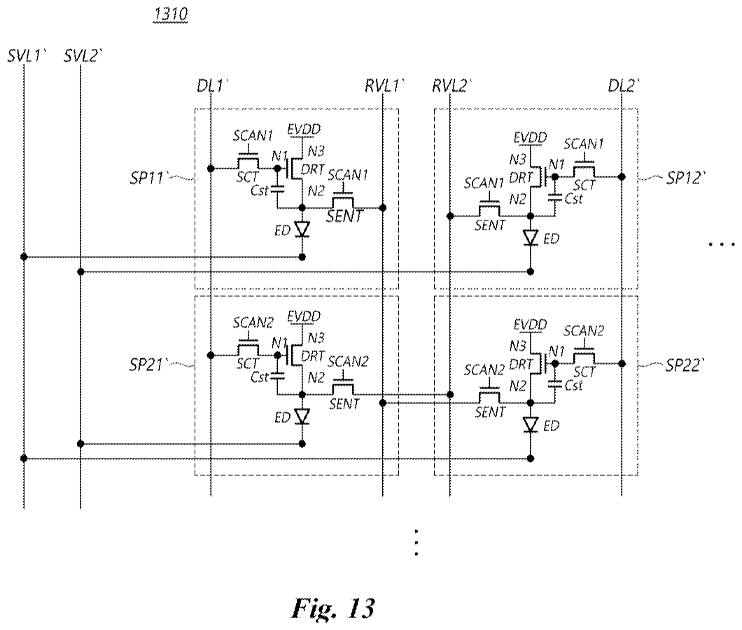

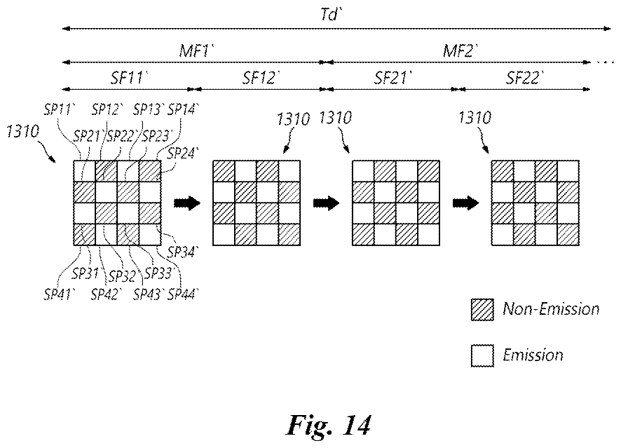

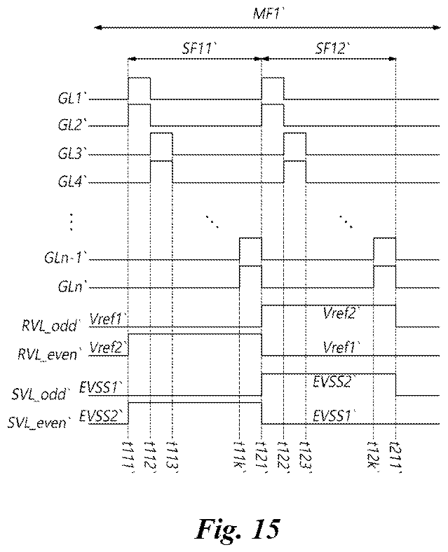

FIG. 13 is a diagram illustrating the circuit structure of subpixels SP disposed in a display panel 1310 in accordance with a fourth embodiment of the present disclosure. FIG. 14 is a diagram illustrating driving of the display panel 1310 in accordance with the fourth embodiment of the present disclosure. FIG. 15 is a diagram illustrating driving timing of a display device 100 in accordance with the fourth embodiment of the present disclosure.

Referring to FIG. 13, in a display panel 1310, a plurality of data lines DL′, a plurality of reference voltage lines RVL′, a plurality of gate lines GL′ and a plurality of subpixels SP′ may be disposed.

Referring to FIG. 13, although the plurality of subpixels SP′ are disposed in the display panel 1310, for the sake of convenience in explanation, the characteristics of the plurality of subpixels SP′ will be described by taking an 11th subpixel SP11′ to a 22nd subpixel SP22′ as an example.

The characteristics of scan transistors SCT, driving transistors DRT, sensing transistors SENT, light emitting elements ED and storage capacitors Cst included in the plurality of subpixels SP′ illustrated in FIG. 13 are the same as those of the plurality of subpixels SP′ illustrated in FIG. 7.

The electrical connection relationship between the plurality of data lines DL′ and the plurality of subpixels SP′ illustrated in FIG. 13 is the same as the electrical connection relationship between the plurality of data lines DL′ and the plurality of subpixels SP′ illustrated in FIG. 7.

The electrical connection relationship between a first reference voltage line RVL1′ and the plurality of subpixels SP′ illustrated in FIG. 13 is the same as the electrical connection relationship between the first reference voltage line RVL1′ and the plurality of subpixels SP′ illustrated in FIG. 7.

The electrical connection relationship between a second reference voltage line RVL2′ and the plurality of subpixels SP′ illustrated in FIG. 13 is the same as the electrical connection relationship between the second reference voltage line RVL2′ and the plurality of subpixels SP′ illustrated in FIG. 7.

The plurality of subpixels SP may be driven in a “one-scan” structure.

Referring to FIG. 13, a plurality of base voltage lines SVL′ may include a first base voltage line SVL1′ and a second base voltage line SVL2′. The plurality of base voltage lines SVL′ may be classified into an odd-numbered base voltage line SVL2a-1′ (a is a natural number) (hereinafter denoted as “SVL_odd′ ”) and an even-numbered base voltage line SVL2a′ (a is a natural number) (hereinafter denoted as “SVL_even′ ”) on the basis of an order in which the plurality of base voltage lines SVL′ are disposed. The first base voltage line SVL1′ may be included in the odd-numbered base voltage line SVL_odd′, and the second base voltage line SVL2′ may be included in the even-numbered base voltage line SVL_even′.

Subpixels SP′ disposed in odd-numbered columns among subpixels SP′ disposed in odd-numbered rows may be electrically connected to odd-numbered base voltage lines SVL2a-1′. Subpixels SP′ disposed in even-numbered columns among subpixels SP′ disposed in even-numbered rows may be electrically connected to odd-numbered base voltage lines SVL2a-1′. For example, the first base voltage line SVL1′ may be electrically connected to the 11th subpixel SP11′ which is disposed in a first row and a first column and the 22nd subpixel SP22′ which is disposed in a second row and a second column.

Subpixels SP′ disposed in even-numbered columns among subpixels SP′ disposed in odd-numbered rows may be electrically connected to even-numbered base voltage lines SVL2a′. Subpixels SP′ disposed in odd-numbered columns among subpixels SP′ disposed in even-numbered rows may be electrically connected to even-numbered base voltage lines SVL2a′. For example, the second base voltage line SVL2′ may be electrically connected to the 12th subpixel SP12′ which is disposed in the first row and the second column and the 21st subpixel SP21′ which is disposed in the second row and the first column.

A first base voltage EVSS1′ or a second base voltage EVSS2′ may be supplied to the first base voltage line SVL1′. The first base voltage EVSS1′ or the second base voltage EVSS2′ may be supplied to the second base voltage line SVL2′.

When the first base voltage EVSS1′ is supplied to the first base voltage line SVL1′, the second base voltage EVSS2′ may be supplied to the second base voltage line SVL2′. When the second base voltage EVSS2′ is supplied to the first base voltage line SVL1′, the first base voltage EVSS1′ may be supplied to the second base voltage line SVL2′.

The magnitude of the second base voltage EVSS2′ may be larger than the magnitude of the first base voltage EVSS1′.

The second base voltage EVSS2′ may be the same voltage as the second reference voltage Vref2, or the second base voltage EVSS2′ may have a voltage magnitude obtained by subtracting the threshold voltage Vth_ED of the light emitting element ED from the second reference voltage Vref2. As the second base voltage EVSS2′ is supplied to the cathode electrode of the light emitting element ED, the light emitting element ED may be maintained in a turn-off state. As the light emitting element ED is maintained in a turn-off state, current may not be supplied and thus the light emitting element ED may not emit light. Namely, by stably controlling the light emitting element ED, a moving picture response time (MPRT) may be efficiently improved.

A feature that the subpixel′ SP is supplied with the second base voltage EVSS2′ and thus the light emitting element ED does not emit light has been described. Next, a feature that, when BDI driving is performed, the display panel 1310 in which the plurality of subpixels SP′ are disposed emits light will be described below.

Referring to FIG. 14, a driving period Td′ of the display device 100 may include a plurality of main frame periods MF′ for displaying an image on the display panel 1310. The characteristics of the plurality of main frame periods MF′ and the light emission characteristics of the plurality of subpixels SP′ illustrated in FIG. 14 are the same as those illustrated in FIG. 8.

The light emission characteristics of the display panel 1310 illustrated in FIG. 14 are the same as the light emission characteristics of the display panel 710 illustrated in FIG. 8.

However, the plurality of subpixels SP′ illustrated in FIG. 14 are different from the plurality of subpixels SP′ illustrated in FIG. 8 in that the base voltage EVSS′ may be controlled to the first base voltage EVSS1′ or the second base voltage EVSS2′.

Referring to FIG. 15, signals supplied to a first gate line GL1′ to an nth gate line GLn′ included in the display device 100 and time points t111′, ′ t211′ at which the signals are supplied may be checked. The display device 100 may include the plurality of reference voltage lines RVL′, and the plurality of reference voltage lines RVL′ may be classified into an odd-numbered reference voltage line RVL_odd′ and an even-numbered reference voltage line RVL_even′ on the basis of an order in which the plurality of reference voltage lines RVL′ are disposed.

A first reference voltage Vref1′ or a second reference voltage Vref2′ may be supplied to the odd-numbered reference voltage line RVL_odd′. The first reference voltage Vref1′ or the second reference voltage Vref2′ may be supplied to the even-numbered reference voltage line RVL_even′. The magnitude of the second reference voltage Vref2′ may be larger than the magnitude of the first reference voltage Vref1′.

Referring to FIG. 15, a first main frame period MF1′ during which the plurality of subpixels SP′ emit light may include an 11th sub frame period SF11′ and a 12th sub frame period SF12′.

In the 11th sub frame period SF11′ and the 12th sub frame period SF12′ shown in FIG. 15, the characteristics of the first gate line GL1′ to the nth gate line GLn′, the odd-numbered reference voltage line RVL_odd′ and the even-numbered reference voltage line RVL_even′ are the same as those shown in FIG. 9. However, there is a difference in that the voltage of the base voltage line SVL′ shown in FIG. 15 is controlled.

Referring to FIG. 15, the plurality of base voltage lines SVL′ may be classified into an odd-numbered base voltage line SVL_odd′ and an even-numbered base voltage line SVL_even′ on the basis of an order in which the plurality of base voltage lines SVL′ are disposed.

The first base voltage EVSS1′ or the second base voltage EVSS2′ may be supplied to the odd-numbered base voltage line SVL_odd′. The first base voltage EVSS1′ or the second base voltage EVSS2′ may be supplied to the even-numbered base voltage line SVL_even′. The magnitude of the second base voltage EVSS2′ may be larger than the magnitude of the first base voltage EVSS1′.

Referring to FIG. 15, the 11th sub frame period SF11′ may be a period in which the first base voltage EVSS1′ is supplied to the odd-numbered base voltage line SVL_odd′ and the second base voltage EVSS2′ is supplied to the even-numbered base voltage line SVL_even′.

Referring to FIG. 15, the 12th sub frame period SF12′ may be a period in which the second base voltage EVSS2′ is supplied to the odd-numbered base voltage line SVL_odd′ and the first base voltage EVSS1 is supplied to the even-numbered base voltage line SVL_even′.

In the 11th sub frame period SF11′, sub pixels SP′ supplied with the first base voltage EVSS1′ may emit light to display a frame image. In the 11th sub frame period SF11′, subpixels SP′ supplied with the second base voltage EVSS2′ may display a black grayscale. Accordingly, the display panel 1310 may emit light like the display panel 1310 during the 11th sub frame period SF11′ of FIG. 14.

In the 12th sub frame period SF12′, sub pixels SP′ supplied with the second base voltage EVSS2′ may emit light to display a frame image. In the 12th sub frame period SF12′, subpixels SP′ supplied with the first base voltage EVSS1′ may display a black grayscale. Accordingly, the display panel 1310 may emit light like the display panel 1310 during the 12th sub frame period SF12′ of FIG. 14.

Namely, according to the fourth embodiment of the present disclosure, while stably controlling the light emitting element ED, a moving picture response time (MPRT) may be efficiently improved.

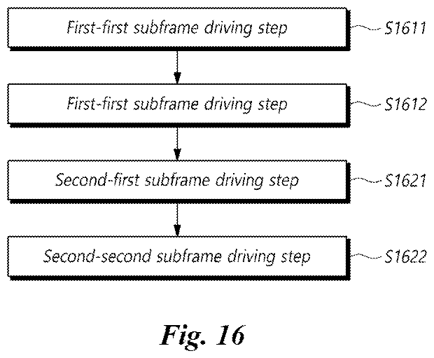

FIG. 16 is a flowchart showing a method for driving the display device 100 in accordance with embodiments of the present disclosure.

The method for driving the display device 100 may include first main frame driving step S1610 and second main frame driving step S1620.

The first main frame driving step S1610 may include first-first sub frame driving step S1611 and first-second sub frame driving step S1612. The second main frame driving step S1620 may include second-first sub frame driving step S1621 and second-second sub frame driving step S1622.

An 11th subpixel SP11 may be electrically connected to a first gate line GL1 and a first data line DL1, and a 21st subpixel SP21 may be electrically connected to a second gate line GL2 and the first data line DL1.

A 12th subpixel SP12 may be electrically connected to the first gate line GL1 and a second data line DL2, and a 22nd subpixel SP22 may be connected to the second gate line GL2 and the second data line DL2.

The 11th subpixel SP11 may be a first subpixel SP, the 21st subpixel SP21 may be a second subpixel SP, the 12th subpixel SP12 may be a third subpixel SP, and the 22nd subpixel SP22 may be a fourth subpixel SP.

The first-first sub frame driving step S1611 may be step in which a first reference voltage Vref1 is supplied to a first reference voltage line RVL1 electrically connected to the 11th subpixel SP11 and a second reference voltage Vref2 is supplied to a second reference voltage line RVL2 electrically connected to the 21st subpixel SP21. The second reference voltage Vref2 may be higher than the first reference voltage Vref1.

The 12th subpixel SP12 may be electrically connected to the first reference voltage line RVL1. The 22nd subpixel SP22 may be electrically connected to the second reference voltage line RVL2. In this case, in the first-first sub frame driving step S1611, the 11th subpixel SP11 and the 12th subpixel SP12 may be in an emission state, and the 21st subpixel SP21 and the 22nd subpixel SP22 may be in a non-emission state.

Alternatively, the 12th subpixel SP12 may be electrically connected to the second reference voltage line RVL2. The 22nd subpixel SP22 may be electrically connected to the first reference voltage line RVL1. In this case, in the first-first sub frame driving step S1611, the 21st subpixel SP21 and the 12th subpixel SP12 may be in a non-emission state, and the 11th subpixel SP11 and the 22nd subpixel SP22 may be in an emission state.

The first-second sub frame driving step S1612 may be step in which the second reference voltage Vref2 is supplied to the first reference voltage line RVL1 and the first reference voltage Vref1 is supplied to the second reference voltage line RVL2.

The 12th subpixel SP12 may be electrically connected to the first reference voltage line RVL1. The 22nd subpixel SP22 may be electrically connected to the second reference voltage line RVL2. In this case, in the first-second sub frame driving step S1612, the 11th subpixel SP11 and the 12th subpixel SP12 may be in a non-emission state, and the 21st subpixel SP21 and the 22nd subpixel SP22 may be in an emission state.

Alternatively, the 12th subpixel SP12 may be electrically connected to the second reference voltage line RVL2. The 22nd subpixel SP22 may be electrically connected to the first reference voltage line RVL1. In this case, in the first-second sub frame driving step S1612, the 21st subpixel SP21 and the 12th subpixel SP12 may be in an emission state, and the 11th subpixel SP11 and the 22nd subpixel SP22 may be in a non-emission state.

The second-first sub frame driving step S1621 may be the same step as the first-first sub frame driving step S1611. That is to say, the second-first sub frame driving step S1621 may be step in which the first reference voltage Vref1 is supplied to the first reference voltage line RVL1 electrically connected to the 11th subpixel SP11 and the second reference voltage Vref2 is supplied to the second reference voltage line RVL2 electrically connected to the 21st subpixel SP21.

The second-second sub frame driving step S1622 may be the same step as the first-second sub frame driving step S1612. That is to say, the second-second sub frame driving step S1622 may be step in which the first reference voltage Vref1 is supplied to the first reference voltage line RVL1 electrically connected to the 11th subpixel SP11 and the second reference voltage Vref2 is supplied to the second reference voltage line RVL2 electrically connected to the 21st subpixel SP21.

In the first-first sub frame driving step S1611 and the second-first sub frame driving step S1621, only some subpixels SP may be in an emission state, and remaining subpixels SP may be in a non-emission state. Since the remaining subpixels SP are in a non-emission state, storage capacitors Cst included in the remaining subpixels SP may be initialized. In other words, since the remaining subpixels SP may be subpixels SP which are electrically connected to an odd-numbered reference voltage line RVL_odd, the storage capacitors Cst included in the remaining subpixels SP may be initialized.

In the first-second sub frame driving step S1612 and the second-second sub frame driving step S1622, only remaining subpixels SP may be in an emission state, and some subpixels SP may be in a non-emission state. Since the some subpixels SP are in a non-emission state, storage capacitors Cst included in the some subpixels SP may be initialized. In other words, since the some subpixels SP may be subpixels SP which are electrically connected to an even-numbered reference voltage line RVL_even, the storage capacitors Cst included in the some subpixels SP may be initialized.

Namely, during the first main frame driving step S1610 and the second main frame driving step S1620 displaying one frame image, storage capacitors Cst included in all subpixels SP undergo an initialization process, and thus, a moving picture response time (MPRT) may be improved.

According to the embodiments of the present disclosure described above, it is possible to provide a display device 100 and a driving method, capable of efficiently improving a moving picture response time (MPRT).

According to the embodiments of the present disclosure, it is possible to provide a display device 100 and a driving method, capable of low-power driving by efficiently improving a moving picture response time (MPRT).

A brief description of the embodiments of the present disclosure described above is as follows.

According to embodiments of the present disclosure, it is possible to provide a display device, wherein a plurality of subpixels electrically connected to a plurality of gate lines, a plurality of data lines and a plurality of reference voltage lines are disposed, wherein a first subpixel is electrically connected to a first data line and a first reference voltage line, wherein a second subpixel is electrically connected to the first data line and a second reference voltage line different from the first reference voltage line, and wherein magnitudes of a voltage supplied to the first reference voltage line and a voltage supplied to the second reference voltage line are different from each other.

A main frame period in which the plurality of subpixels emit light may include a first sub frame period in which a first reference voltage is supplied to the first reference voltage line and a second reference voltage is supplied to the second reference voltage line, and a second sub frame period in which the second reference voltage is supplied to the first reference voltage line and the first reference voltage is supplied to the second reference voltage line.

The second reference voltage may be higher than the first reference voltage.

A magnitude of the second reference voltage may be larger than a magnitude of a data voltage supplied to the plurality of data lines in the main frame period, or a magnitude of the second reference voltage may be the same as a magnitude of the data voltage.

The second reference voltage may be lower than a threshold voltage of a light emitting element supplied with the second reference voltage.

The second reference voltage may be higher than a threshold voltage of a light emitting element supplied with the second reference voltage.

The plurality of subpixels may be electrically connected to a plurality of base voltage lines, the first subpixel may be electrically connected to a first base voltage line, the second subpixel may be electrically connected to a second base voltage line different from the first base voltage line, and magnitudes of a voltage supplied to the first base voltage line and a voltage supplied to the second base voltage line may be different from each other.

The first subpixel may be electrically connected to a first gate line, the second subpixel may be electrically connected to a second gate line, and gate signals may be supplied to the first gate line and the second gate line at the same time point.

The display device may further include a third subpixel electrically connected to the first gate line and a second data line; and a fourth subpixel electrically connected to the second gate line and the second data line.

The third subpixel may be electrically connected to the first reference voltage line, and the fourth subpixel may be electrically connected to the second reference voltage line.

The third subpixel may be electrically connected to the second reference voltage line, and the fourth subpixel may be electrically connected to the first reference voltage line.

The first subpixel may include a driving transistor for driving a light emitting element, a scan transistor electrically connected between a first node being a gate node of the driving transistor and the first data line, and a sensing transistor electrically connected to a second node of the driving transistor and the first reference voltage line.

According to embodiments of the present disclosure, it is possible to provide a method for driving a display device in which a plurality of subpixels electrically connected to a plurality of gate lines, a plurality of data lines and a plurality of reference voltage lines are disposed, including: first sub frame driving step in which a first reference voltage is supplied to a first reference voltage line electrically connected to a first subpixel and a second reference voltage is supplied to a second reference voltage line electrically connected to a second subpixel, and second sub frame driving step in which the second reference voltage is supplied to the first reference voltage line and the first reference voltage is supplied to the second reference voltage line.

The second reference voltage may be higher than the first reference voltage.

The first subpixel may be electrically connected to a first gate line, the second subpixel may be electrically connected to a second gate line, and gate signals may be supplied to the first gate line and the second gate line at the same time point.

The first subpixel and the second subpixel may be electrically connected to a first data line, a third subpixel may be electrically connected to the first gate line and a second data line, and a fourth subpixel may be electrically connected to the second gate line and the second data line.

The third subpixel may be electrically connected to the first reference voltage line, and the fourth subpixel may be electrically connected to the second reference voltage line.

In the first sub frame driving step, the first subpixel and the third subpixel may be in an emission state, and the second subpixel and the fourth subpixel may be in a non-emission state.

The third subpixel may be electrically connected to the second reference voltage line, and the fourth subpixel may be electrically connected to the first reference voltage line.

In the first sub frame driving step, the second subpixel and the third subpixel may be in a non-emission state, and the first subpixel and the fourth subpixel may be in an emission state.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a plurality of subpixels electrically connected to a plurality of gate lines, a plurality of data lines and a plurality of reference voltage lines;
wherein a first subpixel is electrically connected to a first data line and a first reference voltage line,
wherein a second subpixel is electrically connected to the first data line and a second reference voltage line different from the first reference voltage line, and
wherein the first reference voltage line and the second reference voltage line are configured to receive voltages of magnitudes different from each other.

2. The display device of claim 1, wherein in operation,
in a first sub frame period of a main frame period in which the plurality of subpixels emit light, a first reference voltage is supplied to the first reference voltage line and a second reference voltage is supplied to the second reference voltage line; and
in a second sub frame period of the main frame period, the second reference voltage is supplied to the first reference voltage line and the first reference voltage is supplied to the second reference voltage line.

3. The display device of claim 2, wherein the second reference voltage is higher than the first reference voltage.

4. The display device of claim 3, wherein a magnitude of the second reference voltage is greater than a magnitude of a data voltage supplied to the plurality of data lines in the main frame period, or the magnitude of the second reference voltage is same as the magnitude of the data voltage.

5. The display device of claim 3, wherein the second reference voltage is lower than a threshold voltage of a light emitting element supplied with the second reference voltage.

6. The display device of claim 3, wherein the second reference voltage is higher than a threshold voltage of a light emitting element supplied with the second reference voltage.

7. The display device of claim 1, wherein:
the plurality of subpixels are electrically connected to a plurality of base voltage lines,
the first subpixel is electrically connected to a first base voltage line,
the second subpixel is electrically connected to a second base voltage line different from the first base voltage line, and
the first base voltage line and the second base voltage line are configured to receive voltages of magnitudes different from each other.

8. The display device of claim 1, wherein:
the first subpixel is electrically connected to a first gate line,
the second subpixel is electrically connected to a second gate line, and
in operation, gate signals are supplied to the first gate line and the second gate line at a same time point.

9. The display device of claim 8, further comprising:
a third subpixel electrically connected to the first gate line and a second data line; and
a fourth subpixel electrically connected to the second gate line and the second data line.

10. The display device of claim 9, wherein:
the third subpixel is electrically connected to the first reference voltage line, and
the fourth subpixel is electrically connected to the second reference voltage line.

11. The display device of claim 9, wherein
the third subpixel is electrically connected to the second reference voltage line, and
the fourth subpixel is electrically connected to the first reference voltage line.

12. The display device of claim 1, wherein the first subpixel comprises:
a driving transistor for driving a light emitting element;
a scan transistor electrically connected between a first node of the driving transistor and the first data line; and
a sensing transistor electrically connected to a second node of the driving transistor and the first reference voltage line.

13. A method for driving a display device in which a plurality of subpixels electrically connected to a plurality of gate lines, a plurality of data lines and a plurality of reference voltage lines are disposed, the method comprising:
in a first sub frame period, supplying a first reference voltage to a first reference voltage line electrically connected to a first subpixel and a second reference voltage to a second reference voltage line electrically connected to a second subpixel; and
in a second sub frame period, supplying the second reference voltage to the first reference voltage line and the first reference voltage to the second reference voltage line.

14. The method of claim 13, wherein the second reference voltage is higher than the first reference voltage.

15. The method of claim 13, wherein:
the first subpixel is electrically connected to a first gate line,
the second subpixel is electrically connected to a second gate line, and
gate signals are supplied to the first gate line and the second gate line at a same time point.

16. The method of claim 15, wherein:
the first subpixel and the second subpixel are electrically connected to a first data line,
a third subpixel is electrically connected to the first gate line and a second data line, and
a fourth subpixel is electrically connected to the second gate line and the second data line.

17. The method of claim 16, wherein:
the third subpixel is electrically connected to the first reference voltage line, and
the fourth subpixel is electrically connected to the second reference voltage line.

18. The method of claim 17, wherein, in the first sub frame period, the first subpixel and the third subpixel are in an emission state, and the second subpixel and the fourth subpixel are in a non-emission state.

19. The method of claim 16, wherein:
the third subpixel is electrically connected to the second reference voltage line, and
the fourth subpixel is electrically connected to the first reference voltage line.

20. The method of claim 19, wherein, in the first sub frame driving period, the second subpixel and the third subpixel are in a non-emission state, and the first subpixel and the fourth subpixel are in an emission state.
